(19) United States
(12) Patent Application Publication
(10) Pub. No.: US 2020/0362244 A1
(43) Pub. Date: Nov. 19, 2020

(54) POLYMERIZABLE LIQUID CRYSTAL COMPOSITION, OPTICALLY ANISOTROPIC FILM, OPTICAL FILM, POLARIZING PLATE, AND IMAGE DISPLAY DEVICE

(71) Applicant: FUJIFILM Corporation, Tokyo (JP)

(72) Inventors: Satoshi SHIMAMURA, Kanagawa (JP); Aiko YOSHIDA, Kanagawa (JP); Keita TAKAHASHI, Kanagawa (JP); Ryo SATAKE, Kanagawa (JP); Mayumi NOJIRI, Kanagawa (JP)

(73) Assignee: FUJIFILM Corporation, Tokyo (JP)

(21) Appl. No.: 16/985,812

(22) Filed: Aug. 5, 2020

Related U.S. Application Data
(63) Continuation of application No. PCT/JP2019/005280, filed on Feb. 14, 2019.

(30) Foreign Application Priority Data
Feb. 14, 2018 (JP) 2018-023890
Jul. 26, 2018 (JP) 2018-140492

(51) Int. Cl. C09K 19/30; C09K 19/34

(52) U.S. Cl. CPC C09K 19/3068; C09K 19/3491; C09K 2019/0448; C09K 2323/031; C09K 2219/03

(57) ABSTRACT

A polymerizable liquid crystal composition used for formation of an optically anisotropic film retaining good reciprocal wavelength dispersibility and having an excellent surface condition, an optically anisotropic film, an optical film, a polarizing plate, and an image display device. The polymerizable liquid crystal composition contains a polymerizable liquid crystal compound represented by Formula (I): L¹-SP¹-A¹-D³-G¹-D¹-Ar-D²-G²-D⁴-A²-SP²-L² and a polymerizable compound represented by Formula (II): L⁵-SP⁵-D⁹-C(═O)-Cy¹-Cy²-C(═O)-D⁷-A⁵-D⁸-(A⁶-D¹⁰)ₙ-SP⁶-L⁶ and not corresponding to Formula (I).

### CROSS-REFERENCE TO RELATED APPLICATIONS

This application is a Continuation of PCT International Application No. PCT/JP2019/005280 filed on Feb. 14, 2019, which claims priority under 35 U.S.C. § 119(a) to Japanese Patent Application No. 2018-023890 filed on Feb. 14, 2018 and Japanese Patent Application No. 2018-140492 filed on Jul. 26, 2018. Each of the above applications is hereby expressly incorporated by reference, in its entirety, into the present application.

### BACKGROUND OF THE INVENTION

### 1. Field of the Invention

The present invention relates to a polymerizable liquid crystal composition, an optically anisotropic film, an optical film, a polarizing plate, and an image display device.

### 2. Description of the Related Art

A polymerizable compound exhibiting reciprocal wavelength dispersibility enables, for example, conversion of accurate light ray wavelengths over a wide wavelength range and reduction in the thickness of a phase difference film due to its high refractive index, and therefore, it has been actively studied.

Furthermore, for a polymerizable compound exhibiting reciprocal wavelength dispersibility, T-type molecular design guidelines have generally been applied and it has been required to decrease the wavelength of a major axis of the molecule and increase the wavelength of a minor axis positioned at the center of the molecule.

In this regard, it is known that a cycloalkylene skeleton having no absorption wavelength is used for the connection between a skeleton of the minor axis positioned at the center of the molecule (hereinafter also referred to as a “reciprocal wavelength dispersion expressing part”) and the major axis of the molecule (see, for example, JP2010-031223A, WO2014/010325A, and JP2016-081035A).

### SUMMARY OF THE INVENTION

The present inventors have conducted studies on the polymerizable compounds exhibiting reciprocal wavelength dispersibility described in JP2010-031223A, WO2014/010325A, and JP2016-081035A, and from the viewpoint of controlling various physical properties such as a phase transition temperature and crystallinity, they have prepared a polymerizable composition using other liquid crystal compounds, polymerizable compounds, and the like described in each of the patent documents in combination, and have thus found that an optically anisotropic film having a good surface state could be manufactured; however, the manufactured optically anisotropic film may have deteriorated reciprocal wavelength dispersibility, depending on a type of the polymerizable compound exhibiting reciprocal wavelength dispersibility and a type of such the other polymerizable compound to be used in combination.

Therefore, an object of the present invention is to provide a polymerizable liquid crystal composition used for formation of an optically anisotropic film retaining good reciprocal wavelength dispersibility and having an excellent surface condition, an optically anisotropic film, an optical film, a polarizing plate, and an image display device.

The present inventors have conducted intensive studies to accomplish the object, and as a result, they have found that an optically anisotropic film formed has an improved surface condition while retaining excellent reciprocal wavelength dispersibility by using a polymerizable liquid crystal composition in which a polymerizable compound having a predetermined structure is blended together with a polymerizable compound exhibiting reciprocal wavelength dispersibility, thereby completing the present invention.

That is, the present inventors have found that the object can be accomplished by the following configurations.

[1] A polymerizable liquid crystal composition comprising:

a polymerizable liquid crystal compound represented by Formula (I) which will described below; and

a polymerizable compound represented by Formula (II) which will be described later and not corresponding to Formula (I) which will be described later.

[2] The polymerizable liquid crystal composition as described in [1],

in which n in Formula (II) which will be described later is an integer of 0 to 2.

[3] The polymerizable liquid crystal composition as described in [1] or [2],

in which A⁵ in Formula (II) which will be described later represents any one ring structure selected from the group consisting of groups represented by Formulae (A5-1) to (A5-5) which will be described later.

[4] The polymerizable liquid crystal composition as described in any one of [1] to [3],

in which the polymerizable compound represented by Formula (II) which will be described later is a polymerizable compound represented by Formula (IIa) which will be described later.

[5] The polymerizable liquid crystal composition as described in [4],

in which D⁷, D⁹, D¹¹, and D¹² in Formula (IIa) which will be described later each independently represent —O— or —N(CH₃)—.

[6] The polymerizable liquid crystal composition as described in any one of [1] to [5],

in which A¹ and A² in Formula (I) which will be described later each independently represent a cycloalkane ring having 6 or more carbon atoms.

[7] An optically anisotropic film obtained by polymerizing the polymerizable liquid crystal composition as described in any one of [1] to [6].

[8] The optically anisotropic film as described in [7],

in which Formula (III) is satisfied,

0.50<Re(450)/Re(550)<1.00 (III)

in Formula (III), Re(450) represents an in-plane retardation of the optically anisotropic film at a wavelength of 450 run, and Re(550) represents an in-plane retardation of the optically anisotropic film at a wavelength of 550 nm.

[9] An optical film comprising the optically anisotropic film as described in [7] or [8].

[10] A polarizing plate comprising:

the optical film as described in [9]; and

a polarizer.

[11] An image display device comprising the optical film as described in [9] or the polarizing plate as described in [10].

According to the present invention, it is possible to provide a polymerizable liquid crystal composition used for formation of an optically anisotropic film retaining good reciprocal wavelength dispersibility and having an excellent surface condition, an optically anisotropic film, an optical film, a polarizing plate, and an image display device.

### BRIEF DESCRIPTION OF THE DRAWINGS

FIG. 1A is a schematic cross-sectional view showing an example of an optical film of an embodiment of the present invention.

FIG. 1B is a schematic cross-sectional view showing an example of the optical film of the embodiment of the present invention.

FIG. 1C is a schematic cross-sectional view showing an example of the optical film of the embodiment of the present invention.

### DESCRIPTION OF THE PREFERRED EMBODIMENTS

Hereinafter, the present invention will be described in detail.

Descriptions on the constitutional requirements which will be described later are made based on representative embodiments of the present invention in some cases, but it should not be construed that the present invention is limited to such embodiments.

Furthermore, in the present specification, a numerical value range expressed using “to” means a range that includes the preceding and succeeding numerical values of “to” as the lower limit value and the upper limit value, respectively.

In addition, in the present specification, the bonding direction of a divalent group (for example, —O—CO—) as noted is not particularly limited unless the bonding position is specified, and for example, in a case where D¹ in Formula (I) which will be described later is —CO—O—, D¹ may be either *1-CO—O-*2 or *1-O—CO—*2, in which *1 represents a bonding position to the Ar side and *2 represents a bonding position to the G¹ side.

[Polymerizable Liquid Crystal Composition]

The polymerizable liquid crystal composition of an embodiment of the present invention is a polymerizable liquid crystal composition containing a polymerizable liquid crystal compound represented by Formula (I) (hereinafter also simply referred to as a “polymerizable compound (I)”) and a polymerizable compound represented by Formula (I) but not corresponding to Formula (II) (hereinafter also simply referred to as a “polymerizable compound (II)”).

L¹-SP¹-A¹-D³-G¹-D¹-Ar-D²-G²-D⁴-A²-SP²-L² (I)

L⁵-SP⁵-D⁹-C(═O)-Cy¹-Cy²-C(═O)-D⁷-A⁵-D⁸-(A⁶-D¹⁰)ₙ-SP⁶-L⁶ (II)

In the present invention, by using the polymerizable liquid crystal composition in which the polymerizable compound (II) and the polymerizable liquid crystal compound (I) are blended as described above, an optically anisotropic film thus formed retains reciprocal wavelength dispersibility and has an improved surface condition.

A reason therefor is not specifically clear, but is presumed to be as follows by the present inventors.

That is, since the polymerizable compound (II) has a structure in which cyclohexane rings are linked to each other via single bonds in the major axis of the molecule, it has a rigid molecular structure and can exhibit high liquid crystallinity. As a result, it is considered that in an optically anisotropic film obtained from the polymerizable liquid crystal composition in which the polymerizable liquid crystal compound (I) and the polymerizable compound (II) are blended, the packing between the stable compounds is maintained, and thus, the surface condition is improved while the reciprocal wavelength dispersibility is retained.

Hereinafter, the respective components of the polymerizable liquid crystal composition of the embodiment of the present invention will be described in detail.

[Polymerizable Liquid Crystal Compound (I)]

The polymerizable liquid crystal compound (I) contained in the polymerizable liquid crystal composition of the embodiment of the present invention is a polymerizable liquid crystal compound represented by Formula (I).

L¹-SP¹-A¹-D³-G¹-D¹-Ar-D²-G²-D⁴-A²-SP²-L² (I)

In addition, in Formula (I), D¹, D², D³, and D⁴ each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Furthermore, in Formula (I), G¹ and G² each independently represent a divalent alicyclic hydrocarbon group having 5 to 8 carbon atoms, which may have a substituent, and one or more of —CH₂— constituting the alicyclic hydrocarbon group may be substituted with —O—, —S—, or —NH—.

Moreover, in Formula (I), A¹ and A² each independently represent an aromatic ring having 6 or more carbon atoms, which may have a substituent, or a cycloalkane ring having 6 or more carbon atoms, which may have a substituent.

Incidentally, in Formula (I), SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent.

In addition, in Formula (I), L¹ and L² each independently represent a monovalent organic group, and at least one of L¹ or L² represents a polymerizable group. It should be noted that in a case where Ar is an aromatic ring represented by Formula (Ar-3) which will be described later, at least one of L¹ or L², or L³ or L⁴ in Formula (Ar-3) represents a polymerizable group.

In Formula (I), the divalent alicyclic hydrocarbon group having 5 to 8 carbon atoms represented by each of G¹ and G² is preferably a 5- or 6-membered ring. Further, the alicyclic hydrocarbon group may be saturated or unsaturated, but is preferably a saturated alicyclic hydrocarbon group. With regard to the divalent alicyclic hydrocarbon group represented by each of G¹ and G², reference can be made to, for example, the description in paragraph [0078] of JP2012-021068A, the contents of which are hereby incorporated by reference.

Furthermore, in Formula (I), for G¹ and G², examples of the substituent which may be contained in the divalent alicyclic hydrocarbon group having 5 to 8 carbon atoms include an alkyl group, an alkoxy group, and a halogen atom.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and the methyl group or the ethyl group is particularly preferable.

As the alkoxy group, for example, an alkoxy group having 1 to 18 carbon atoms is preferable, an alkoxy group having 1 to 8 carbon atoms (for example, a methoxy group, an ethoxy group, an n-butoxy group, and a methoxy ethoxy group) is more preferable, an alkoxy group having 1 to 4 carbon atoms is still more preferable, and the methoxy group or the ethoxy group is particularly preferable.

Examples of the halogen atom include a fluorine atom, a chlorine atom, a bromine atom, and an iodine atom, and among these, the fluorine atom or the chlorine atom is preferable.

In Formula (I), examples of the aromatic ring having 6 or more carbon atoms represented by each of A¹ and A² include an aromatic hydrocarbon ring such as a benzene ring, a naphthalene ring, an anthracene ring, and a phenanthroline ring; and an aromatic heterocyclic ring such as a furan ring, a pyrrole ring, a thiophene ring, a pyridine ring, a thiazole ring, and a benzothiazole ring. Among those, the benzene ring (for example, a 1,4-phenyl group) is preferable.

Furthermore, in Formula (I), examples of the cycloalkane ring having 6 or more carbon atoms represented by each of A¹ and A² include a cyclohexane ring, a cyclopeptane ring, a cyclooctane ring, a cyclododecane ring, and a cyclodocosane ring, and among these, the cyclohexane ring (for example, a cyclohexane-1,4-diyl group) is preferable.

In addition, for A¹ and A², examples of the substituent which may be contained in the aromatic ring having 6 or more carbon atoms or the cycloalkane ring having 6 or more carbon atoms include the same ones as the substituents which may be contained in G¹ and G² in Formula (I).

Suitable examples of the linear or branched alkylene group having 1 to 12 carbon atoms represented by each of SP¹ and SP² in Formula (I) include a methylene group, an ethylene group, a propylene group, a butylene group, a pentylene group, a hexylene group, a methylhexylene group, and a heptylene group. Incidentally, in Formula (I), SP¹ and SP² may be a divalent linking group in which one or more of —CH₂—'s constituting the linear or branched alkylene group having 1 to 12 carbon atoms are substituted with —O—, —S—, —NH—, —N(Q)-, or —CO—, and examples of the substituent represented by Q include the same ones as the substituents which may be contained in G¹ and G² in Formula (I).

In Formula (I), examples of the monovalent organic group represented by each of L¹ and L² include an alkyl group, an aryl group, and a heteroaryl group. The alkyl group may be linear, branched, or cyclic, but is preferably linear. The number of carbon atoms of the alkyl group is preferably 1 to 30, more preferably 1 to 20, and still more preferably 1 to 10. Further, the aryl group may be a monocycle or a polycycle, but is preferably the monocycle. The number of carbon atoms of the aryl group is preferably 6 to 25, and more preferably 6 to 10. Further, the heteroaryl group may be a monocycle or a polycycle. The number of heteroatoms constituting the heteroaryl group is preferably 1 to 3. The heteroatoms constituting the heteroaryl group is preferably a nitrogen atom, a sulfur atom, or an oxygen atom. The number of carbon atoms of the heteroaryl group is preferably 6 to 18, and more preferably 6 to 12. In addition, the alkyl group, the aryl group, and the heteroaryl group may be unsubstituted or have a substituent. Examples of the substituent include the same ones as the substituents which may be contained in G¹ and G² in Formula (I).

In Formula (I), the polymerizable group represented by at least one of L¹ or L² is not particularly limited, but is preferably a polymerizable group which is radically polymerizable or cationically polymerizable.

A generally known radically polymerizable group can be used as the radically polymerizable group, and suitable examples thereof include an acryloyl group and a methacryloyl group. In this case, it is known that the acryloyl group generally has a high polymerization rate, and from the viewpoint of improvement of productivity, the acryloyl group is preferable but the methacryloyl group can also be used in the same manner as the polymerizable group.

A generally known cationically polymerizable group can be used as the cationically polymerizable group, and specific examples thereof include an alicyclic ether group, a cyclic acetal group, a cyclic lactone group, a cyclic thioether group, a spiroorthoester group, and a vinyloxy group. Among those, the alicyclic ether group or the vinyloxy group is preferable, and an epoxy group, an oxetanyl group, or the vinyloxy group is particularly preferable.

Particularly preferred examples of the polymerizable group include the following groups.

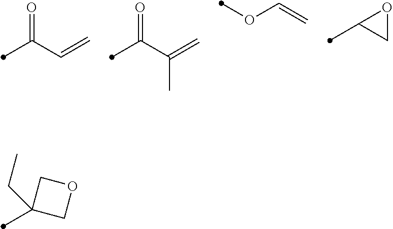

In Formula (I), for a reason that the durability is improved, both of L¹ and L² in Formula (I) are preferably a polymerizable group, and more preferably an acryloyl group or a methacryloyl group.

On the other hand, in Formula (I), Ar represents any aromatic ring selected from the group consisting of groups represented by Formulae (Ar-1) to (Ar-5). Further, in Formulae (Ar-1) to (Ar-5), * represents a bonding position to D¹ or D² in Formula (I).

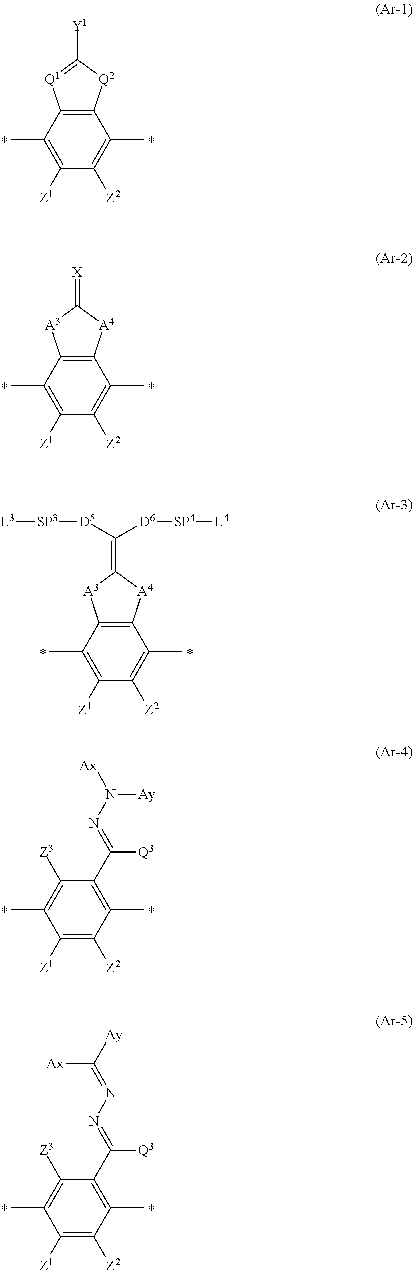

Here, in Formula (Ar-1), Q¹ represents N or CH, Q² represents —S—, —O—, or —N(R⁵)—, R⁵ represents a hydrogen atom or an alkyl group having 1 to 6 carbon atoms, and Y¹ represents an aromatic hydrocarbon group having 6 to 12 carbon atoms or an aromatic heterocyclic group having 3 to 12 carbon atoms, each of which may have a substituent.

Specific examples of the alkyl group having 1 to 6 carbon atoms represented by R⁵ include a methyl group, an ethyl group, a propyl group, an isopropyl group, an n-butyl group, an isobutyl group, a sec-butyl group, a tert-butyl group, an n-pentyl group, and an n-hexyl group.

Examples of the aromatic hydrocarbon group having 6 to 12 carbon atoms represented by Y¹ include aryl groups such as a phenyl group, a 2,6-diethylphenyl group, and a naphthyl group.

Examples of the aromatic heterocyclic group having 3 to 12 carbon atoms represented by Y¹ include heteroaryl groups such as a thienyl group, a thiazolyl group, a furyl group, and a pyridyl group.

In addition, examples of the substituent which may be contained in Y¹ include the same ones as the substituents which may be contained in G¹ and G² in Formula (I).

In addition, in Formulae (Ar-1) to (Ar-5), Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁶, —NR⁷R⁸, or —SR⁹, R⁶ to R⁹ each independently represent a hydrogen atom or an alkyl group having 1 to 6 carbon atoms, and Z¹ and Z² may be bonded to each other to form an aromatic ring.

As the monovalent aliphatic hydrocarbon group having 1 to 20 carbon atoms, an alkyl group having 1 to 15 carbon atoms is preferable, an alkyl group having 1 to 8 carbon atoms is more preferable, and specifically, a methyl group, an ethyl group, an isopropyl group, a tert-pentyl group (1,1-dimethylpropyl group), a tert-butyl group, or a 1,1-dimethyl-3,3-dimethyl-butyl group is still more preferable, and the methyl group, the ethyl group, and the tert-butyl group are particularly preferable.

Examples of the monovalent aromatic hydrocarbon group having 3 to 20 carbon atoms include monocyclic saturated hydrocarbon groups such as a cyclopropyl group, a cyclobutyl group, a cyclopentyl group, a cyclohexyl group, a cycloheptyl group, a cyclooctyl group, a cyclodecyl group, a methylcyclohexyl group, and an ethylcyclohexyl group; monocyclic unsaturated hydrocarbon groups such as a cyclobutenyl group, a cyclopentenyl group, a cyclohexenyl group, a cycloheptenyl group, a cyclooctenyl group, a cyclodecenyl group, a cyclopentadienyl group, a cyclohexadienyl group, a cyclooctadienyl group, and a cyclodecadiene; and polycyclic saturated hydrocarbon groups such as a bicyclo[2.2.1]heptyl group, a bicyclo[2.2.2]octyl group, a tricyclo[5.2.1.0^{2,6}]decyl group, a tricyclo[3.3.1.1^{3,7}]decyl group, a tetracyclo[6.2.1.1^{3,6}.0^{2,7}]dodecyl group, and an adamantyl group.

Specific examples of the monovalent aromatic hydrocarbon group having 6 to 20 carbon atoms include a phenyl group, a 2,6-diethylphenyl group, a naphthyl group, and a biphenyl group, and an aryl group having 6 to 12 carbon atoms (particularly a phenyl group) is preferable.

Examples of the halogen atom include a fluorine atom, a chlorine atom, a bromine atom, and an iodine atom, and among these, die fluorine atom, the chlorine atom, or the bromine atom is preferable.

On the other hand, specific examples of the alkyl group having 1 to 6 carbon atoms represented by each of R⁶ to R⁹ include a methyl group, an ethyl group, a propyl group, an isopropyl group, an n-butyl group, an isobutyl group, a sec-butyl group, a tert-butyl group, an n-pentyl group and an n-hexyl group.

In addition, in Formulae (Ar-2) and (Ar-3), A³ and A⁴ each independently represent a group selected from the group consisting of —O—, —N(R¹⁰)—, —S—, and —CO—, and R¹⁰ represents a hydrogen atom or a substituent.

Examples of the substituent represented by R¹⁰ include the same ones as the substituents which may be contained in G¹ and G² in Formula (I).

Furthermore, in Formula (Ar-2), X represents a hydrogen atom or a non-metal atom of Group XIV to XVI to which a substituent may be bonded.

Moreover, examples of the non-metal atom of Group XIV to XVI represented by X include an oxygen atom, a sulfur atom, a nitrogen atom having a substituent, and a carbon atom having a substituent, and specific examples of the substituent include an alkyl group, an alkoxy group, an alkyl-substituted alkoxy group, a cyclic alkyl group, an aryl group (for example, a phenyl group and a naphthyl group), a cyano group, an amino group, a nitro group, an alkylcarbonyl group, a sulfo group, and a hydroxyl group.

In addition, in Formula (Ar-3), D⁵ and D⁶ each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—. R¹, R², R³, and R⁴ each independently represent a hydrogen atom, a fluorine atom, or an alkyl group having 1 to 4 carbon atoms.

Moreover, in Formula (Ar-3), SP³ and SP⁴ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent. Examples of the substituent include the same ones as the substituents which may be contained in G¹ and G² in Formula (I).

Furthermore, in Formula (Ar-3), L³ and L⁴ each independently represent a monovalent organic group, and at least one of L³ or L⁴, or L¹ or L² in Formula (I) represents a polymerizable group.

Examples of the monovalent organic group include the same ones as the monovalent organic groups described for L¹ and L² in Formula (I).

In addition, examples of the polymerizable group include the same ones as the polymerizable groups described for L¹ and L² in Formula (I).

Moreover, in Formulae (Ar-4) and (Ar-5), Ax represents an organic group having 2 to 30 carbon atoms, which has at least one aromatic ring selected from the group consisting of an aromatic hydrocarbon ring and an aromatic heterocyclic ring.

Furthermore, in Formulae (Ar-4) and (Ar-5), Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring.

Here, the aromatic rings in each of Ax and Ay may have a substituent, and Ax and Ay may be bonded to each other to form a ring.

In addition, Q³ represents a hydrogen atom, or an alkyl group having 1 to 6 carbon atoms, which may have a substituent

Examples of each of Ax and Ay include the ones described in paragraphs [0039] to [0095] of WO2014/010325A.

Incidentally, specific examples of the alkyl group having 1 to 6 carbon atoms represented by Q³ include a methyl group, an ethyl group, a propyl group, an isopropyl group, an n-butyl group, an isobutyl group, a sec-butyl group, a tert-butyl group, an n-pentyl group, and an n-hexyl group, and examples of the substituent include the same ones as the substituents which may be contained in G¹ and G² in Formula (I).

Specific examples of the polymerizable liquid crystal compound (I) represented by Formula (I) include the compound represented by General Formula (I) described in JP2008-297210A (in particular, the compounds described in paragraph Nos. [0034] to [0039]), the compounds represented by General Formula (I) described in JP2010-084032A (in particular, the compounds described in paragraph Nos. [0067] to [0073]), the compound represented by General Formula (II) described in JP2016-053709A (in particular, the compounds described in paragraph Nos. [0036] to [0043]), and the compounds described in JP2016-081035A (in particular, the compounds described in paragraph Nos. [0043] to [0055]).

In the present invention, for a reason that the reciprocal wavelength dispersibility is improved, the polymerizable liquid crystal compound (I) represented by Formula (I) is preferably a polymerizable liquid crystal compound in which A¹ and A² in Formula (I) each independently represent a cycloalkane ring having 6 or more carbon atoms, and more preferably a polymerizable liquid crystal compound in which A¹ and A² in Formula (I) each independently represent a cycloalkane ring having 6 or more carbon atoms, and both of D³ and D⁴ in Formula (I) represent a single bond.

Suitable examples of such a polymerizable liquid crystal compound include compounds represented by Formulae (1) to (12), and specifically the compounds having side chain structures shown in Tables 1 and 2 below as K. (side chain structure) in Formulae (1) to (12).

Furthermore, in Tables 1 and 2 below, “*” shown in the side chain structure of K represents a bonding position to an aromatic ring.

Incidentally, in the following description, a compound represented by Formula (I) and having a group shown in 1-1 in Table 1 below is noted as “Compound (1-1-1)”, and compounds having other structural formulae and groups are also noted in the same manner. For example, a compound represented by Formula (2) and having a group shown in 2-3 in Table 2 below can be noted as “Compound (2-2-3)”.

In addition, in the side chain structures shown in 1-2 in Table 1 below and 2-2 in Table 2 below, a group adjacent to each of the acryloyloxy group and the methacryloyl group represents a propylene group (a group in which a methyl group is substituted with an ethylene group), and represents a mixture of position isomers in which the positions of the methyl groups are different.

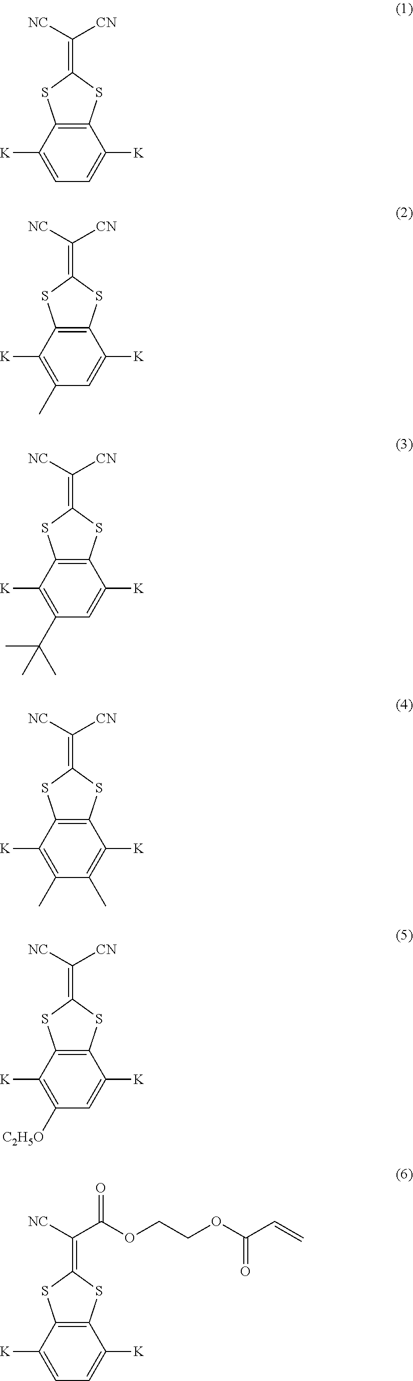

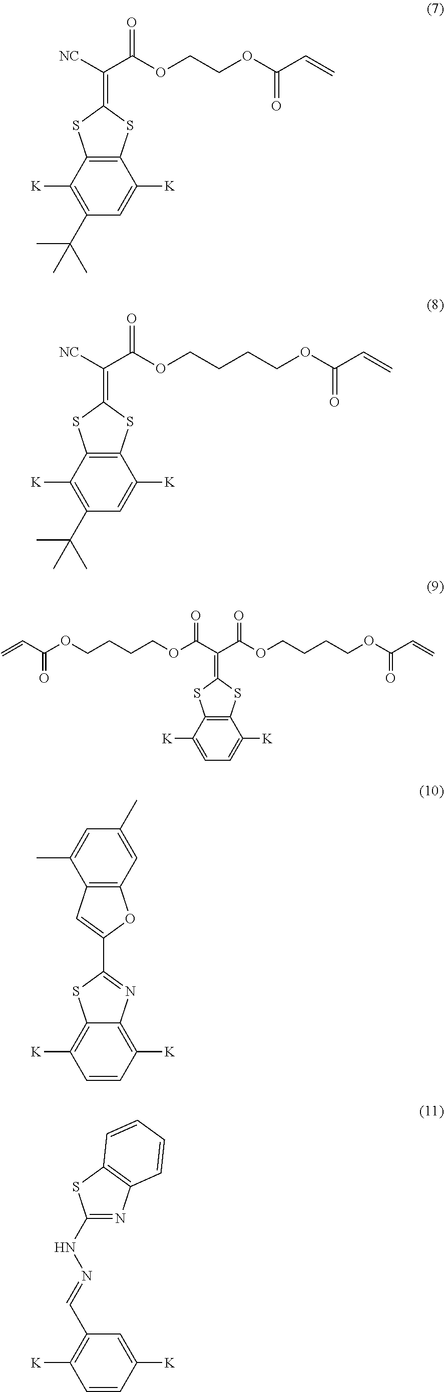

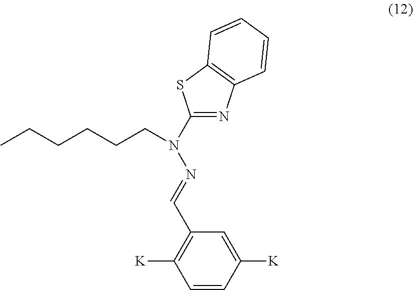

TABLE 1

| | K (side chain structure) |
|---|---|
| 1-1 | 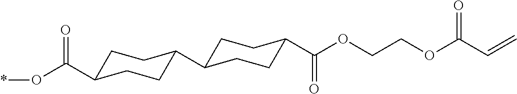 [SMILES: *OC(=O)C1CCC(C2CCC(C(=O)OCCOC(=O)C=C)CC2)CC1] |
| 1-2 | 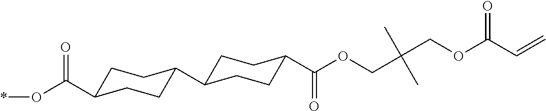 [SMILES: *OC(=O)C1CCC(C2CCC(C(=O)OCC(C)(C)COC(=O)C=C)CC2)CC1] |
| 1-3 | 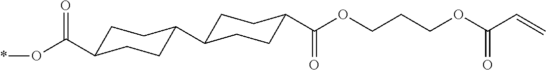 [SMILES: *OC(=O)C1CCC(C2CCC(C(=O)OCCCOC(=O)C=C)CC2)CC1] |
| 1-4 | 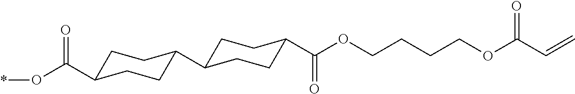 [SMILES: *OC(=O)C1CCC(C2CCC(C(=O)OCCCCOC(=O)C=C)CC2)CC1] |
| 1-5 | 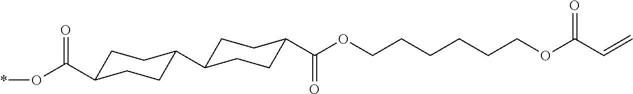 [SMILES: *OC(=O)C1CCC(C2CCC(C(=O)OCCCCCCOC(=O)C=C)CC2)CC1] |
| 1-6 | 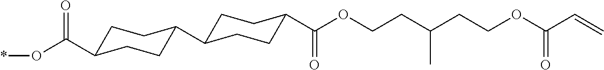 [SMILES: *OC(=O)C1CCC(C2CCC(C(=O)OCCC(C)CCOC(=O)C=C)CC2)CC1] |
| 1-7 | 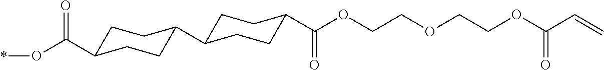 [SMILES: *OC(=O)C1CCC(C2CCC(C(=O)OCCOCCOC(=O)C=C)CC2)CC1] |
| 1-8 | 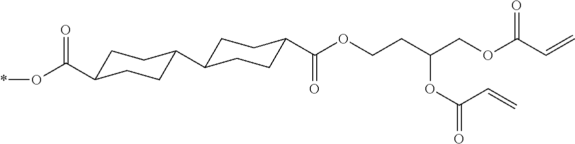 [SMILES: *OC(=O)C1CCC(C2CCC(C(=O)OCCC(COC(=O)C=C)OC(=O)C=C)CC2)CC1] |
| 1-9 | 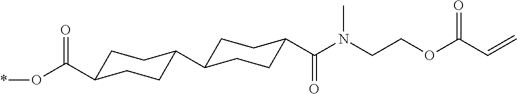 [SMILES: *OC(=O)C1CCC(C2CCC(C(=O)N(C)CCOC(=O)C=C)CC2)CC1] |
| 1-10 | 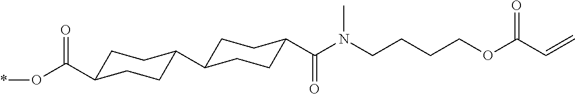 [SMILES: *OC(=O)C1CCC(C2CCC(C(=O)N(C)CCCCOC(=O)C=C)CC2)CC1] |
| 1-11 | 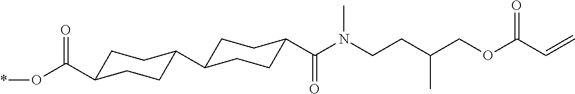 [SMILES: *OC(=O)C1CCC(C2CCC(C(=O)N(C)CCC(C)COC(=O)C=C)CC2)CC1] |
| 1-12 | 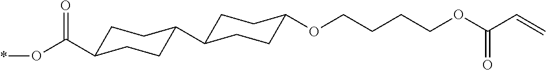 [SMILES: *OC(=O)C1CCC(C2CCC(OCCCCOC(=O)C=C)CC2)CC1] |
| 1-13 | 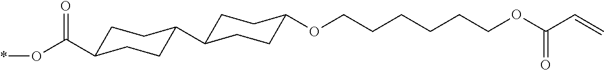 [SMILES: *OC(=O)C1CCC(C2CCC(OCCCCCCOC(=O)C=C)CC2)CC1] |

TABLE 2

| | K (side chain structure) |
|---|---|
| 2-1 | 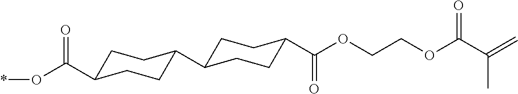 [SMILES: *OC(=O)C1CCC(C2CCC(C(=O)OCCOC(=O)C(=C)C)CC2)CC1] |
| 2-2 | 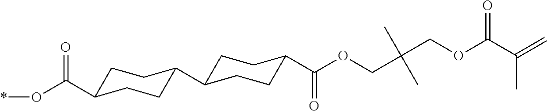 [SMILES: *OC(=O)C1CCC(C2CCC(C(=O)OCC(C)(C)COC(=O)C(=C)C)CC2)CC1] |
| 2-3 | 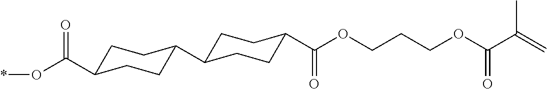 [SMILES: *OC(=O)C1CCC(C2CCC(C(=O)OCCCOC(=O)C(=C)C)CC2)CC1] |
| 2-4 | 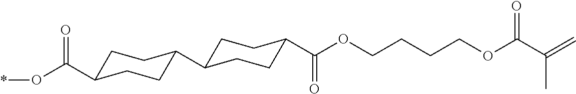 [SMILES: *OC(=O)C1CCC(C2CCC(C(=O)OCCCCOC(=O)C(=C)C)CC2)CC1] |
| 2-5 | 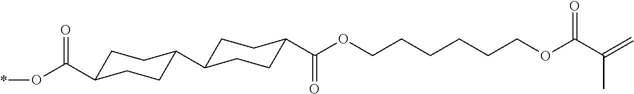 [SMILES: *OC(=O)C1CCC(C2CCC(C(=O)OCCCCCCOC(=O)C(=C)C)CC2)CC1] |
| 2-6 | 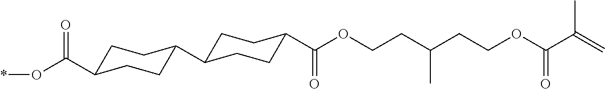 [SMILES: *OC(=O)C1CCC(C2CCC(C(=O)OCCC(C)CCOC(=O)C(=C)C)CC2)CC1] |
| 2-7 | 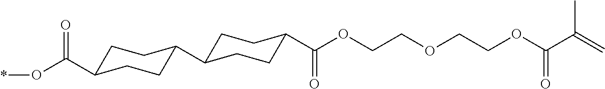 [SMILES: *OC(=O)C1CCC(C2CCC(C(=O)OCCOCCOC(=O)C(=C)C)CC2)CC1] |
| 2-8 | 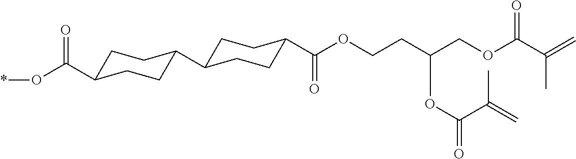 [SMILES: *OC(=O)C1CCC(C2CCC(C(=O)OCCC(COC(=O)C(=C)C)OC(=O)C(=C)C)CC2)CC1] |
| 2-9 | 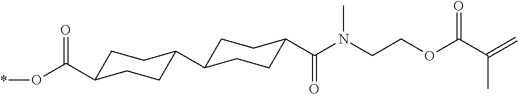 [SMILES: *OC(=O)C1CCC(C2CCC(C(=O)N(C)CCOC(=O)C(=C)C)CC2)CC1] |
| 2-10 | 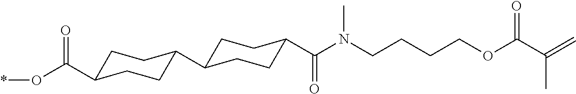 [SMILES: *OC(=O)C1CCC(C2CCC(C(=O)N(C)CCCCOC(=O)C(=C)C)CC2)CC1] |
| 2-11 | 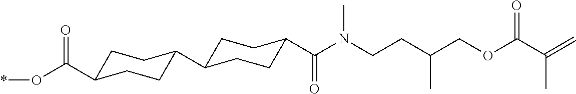 [SMILES: *OC(=O)C1CCC(C2CCC(C(=O)N(C)CCC(C)COC(=O)C(=C)C)CC2)CC1] |
| 2-12 | 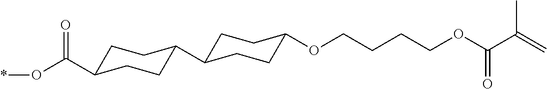 [SMILES: *OC(=O)C1CCC(C2CCC(OCCCCOC(=O)C(=C)C)CC2)CC1] |
| 2-13 | 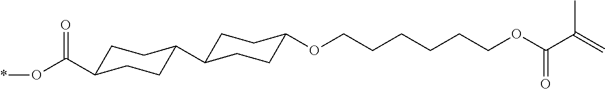 [SMILES: *OC(=O)C1CCC(C2CCC(OCCCCCCOC(=O)C(=C)C)CC2)CC1] |

[Polymerizable Compound (II)]

The polymerizable compound (II) contained in the polymerizable liquid crystal composition of the embodiment of the present invention is a polymerizable compound represented by Formula (II).

L⁵-SP⁵-D⁹-C(═O)-Cy¹-Cy²-C(═O)-D⁷-A⁵-D⁸-(A⁶-D¹⁰)ₙ-SP⁶-L⁶ (II)

In Formula (II), Cy¹ and Cy² each represent a 1,4-cyclohexylene group.

Furthermore, in Formula (II), D⁷ represents a single bond, —O—, —S—, —NR¹¹—, *—O—CR¹¹R¹²—, or *—O—CR¹¹R¹²—CR¹³R¹⁴—. It should be noted that * represents a bonding position to C(═O), and R¹¹, R¹², R¹³, and R¹⁴ each independently represent a hydrogen atom, a fluorine atom, or an alkyl group having 1 to 4 carbon atoms.

Moreover, in Formula (II), D⁹ represents a single bond, —O—, —S—, or —NR¹¹—, and R^{u} represents a hydrogen atom, a fluorine atom, or an alkyl group having 1 to 4 carbon atoms.

In addition, in Formula (II), D⁸ and D¹⁰ each independently represent a single bond, or a divalent linking group consisting of —CO—, —O—, —S—, —C(═S)—, —CR¹¹R¹²—, —CR¹¹═CR¹²—, —NR¹¹—, or a combination of two or more thereof, and R¹¹ and R¹² each independently represent a hydrogen atom, a fluorine atom, or an alkyl group having 1 to 4 carbon atoms.

Incidentally, in Formula (II), SP⁵ and SP⁶ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent.

Furthermore, in Formula (II), L⁵ and L⁶ each independently represent a monovalent organic group, and at least L⁵ of L⁵ and L⁶ represents a polymerizable group.

Moreover, in Formula (II), A⁵ and A⁶ each independently represent an aromatic ring, a heterocyclic ring, or an alicyclic ring, each of which may have a substituent.

In addition, in Formula (II), n represents an integer of 0 to 3, and in a case where n is 2 or 3, a plurality of A⁶'s may be the same as or different from each other and a plurality of D¹⁰'s may be the same as or different from each other.

In Formula (II), Cy¹ and Cy² each represent a 1,4-cyclohexylene group, and in the present invention, it is preferably the trans-1,4-cyclohexylene group.

In Formula (II), D⁷ is preferably a single bond, —O—, —NR¹¹—, *—O—CH₂—, or *—O—CH₂—CH₂—, more preferably a single bond or —O—, and still more preferably —O—.

In addition, D⁹ is preferably —O— or —NR¹¹, and more preferably —O—.

In Formula (II), examples of the divalent linking group represented by each of D⁸ and D¹⁰ include —CO—O—, —C(═S)O—, —CR¹¹R¹²—, —CR¹¹R¹²—CR¹¹R¹²—, —O—CR¹¹R¹²—, —CR¹¹R¹²—O—CR¹¹R¹²—, —CO—O—CR¹¹R¹²—, —O—CO—CR¹¹R¹²—, —CR¹¹R¹²—O—CO—CR¹¹R¹²—, —CR¹¹R¹²—CO—O—CR¹¹R¹²—, —NR¹¹—CR¹¹R¹²—, and —CO—NR¹¹—. Among those, —CO—O— is preferable. R¹¹ and R¹² each independently represent a hydrogen atom, a fluorine atom, or an alkyl group having 1 to 4 carbon atoms.

Suitable examples of the linear or branched alkylene group having 1 to 12 carbon atoms represented by each of SP⁵ and SP⁶ in Formula (II) include a methylene group, an ethylene group, a propylene group, a butylene group, a pentylene group, a hexylene group, a methylhexylene group, and a heptylene group. Further, SP⁵ and SP⁶ may be a divalent linking group in which one or more of —CH₂—'s constituting the linear or branched alkylene group having 1 to 12 carbon atoms are substituted with —O—, —S—, —NH—, —N(Q)-, or —CO—, and examples of the substituent represented by Q include the same ones as the substituents which may be contained in G¹ and G² in Formula (I).

In Formula (II), examples of the organic group represented by each of L⁵ and L⁶ include the same ones as the organic groups represented by one aspect of L¹ and L² in Formula (I), and examples of the polymerizable group represented by at least L⁵ of L⁵ and L⁶ include the same ones as the polymerizable group represented by one aspect of L¹ and L² in Formula (I).

In the present invention, it is preferable that both of L⁵ and L⁶ are polymerizable groups.

Furthermore, in Formula (II), examples of the aromatic ring having 6 or more carbon atoms represented by each of A⁵ and A⁶ include an aromatic hydrocarbon ring such as a benzene ring, a naphthalene ring, an anthracene ring, and a phenanthroline ring; and an aromatic heterocyclic ring such as a furan ring, a pyrrole ring, a thiophene ring, a pyridine ring, a thiazole ring, and a benzothiazole ring. Among those, the benzene ring (for example, a 1,4-phenyl group) is preferable.

Furthermore, in Formula (II), examples of the heterocyclic ring represented by each of A⁵ and A⁶ include, in addition to the above-mentioned aromatic heterocyclic rings, a pyrimidine ring, a piperazine ring, a piperidine ring, and a 1,3-dioxane ring.

In addition, in Formula (II), examples of the alicyclic ring represented by each of A⁵ and A⁶ include a cycloalkane ring having 6 or more carbon atoms, and specifically, for example, a cyclohexane ring, a cyclopeptane ring, a cyclooctane ring, a cyclododecane ring, and a cyclodocosane ring. Among those, the cyclohexane ring (for example, a cyclohexane-1,4-diyl group) is preferable.

In addition, for A⁵ and A⁶, examples of the substituent which may be contained in the aromatic ring, the heterocyclic ring, and the heterocyclic ring include the same ones as the substituents which may be contained in G¹ and G² in Formula (I).

In Formula (II), n represents an integer of 0 to 3, and in the present invention, n is preferably an integer of 0 to 2 from the viewpoints of a phase transition temperature and crystallinity.

In the present invention, the polymerizable compound represented by Formula (II) is preferably a polymerizable compound represented by Formula (IIa) from the viewpoint of facilitating synthesis.

L⁵-SP⁵-D⁹-C(═O)-Cy¹-Cy²-C(═O)-D⁷-A⁵-D¹1-C(═O)-Cy³-Cy⁴-C(═O)-D¹²-SP⁶-L⁶ (IIa)

Here, in Formula (IIa), Cy¹, Cy², D⁷, D⁹, SP⁵, SP⁶, L⁵, L⁶, and A⁵ are each the same as those in Formula (II).

In Formula (IIa), Cy³ and Cy⁴ each represent a 1,4-cyclohexylene group, and in the present invention, it is preferably a trans-1,4-cyclohexylene group.

In the present invention, the polymerizable compound represented by Formula (II) is preferably a polymerizable compound in which D⁷, D⁹, D¹¹, and D¹² in Formula (IIa) each independently represent —O— or —N(CH₃), and more preferably a polymerizable compound in which D⁷, D⁹, D¹¹, and D¹² in Formula (IIa) each independently represent —O—.

In Formula (II) or Formula (IIa), the side chain structure on the left side of A⁵, that is, L⁵-SP⁵-D⁹-C(═O)-Cy¹-Cy²-C(═O)-D⁷- include side chain structures 3-1 to 3-14 and 4-1 to 4-14 shown in Tables 3 and 4 below.

Furthermore, in Tables 3 and 4 below, “*” shown in the side chain structure represents a bonding position to A⁵. In addition, in the side chain structure shown in 3-2 in Table 3 below and 4-2 in Table 4 below, a group adjacent to each of the acryloyloxy group and the methacryloyl group represents a propylene group (a group in which a methyl group is substituted with an ethylene group), and represents a mixture of position isomers in which the positions of the methyl groups are different.

TABLE 3

| | Side chain structure |
|---|---|
| | -D⁷-C(═O)-Cy²-Cy¹-C(═O)-D⁹-SP⁵-L⁵ |
| 3-1 | 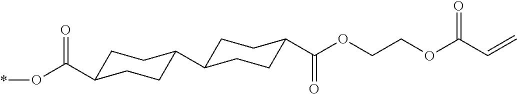 [SMILES: *OC(=O)C1CCC(C2CCC(C(=O)OCCOC(=O)C=C)CC2)CC1] |
| 3-2 | 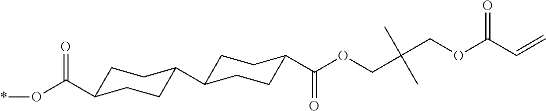 [SMILES: *OC(=O)C1CCC(C2CCC(C(=O)OCC(C)(C)COC(=O)C=C)CC2)CC1] |
| 3-3 | 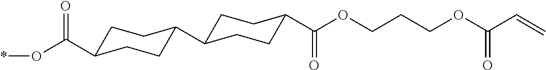 [SMILES: *OC(=O)C1CCC(C2CCC(C(=O)OCCCOC(=O)C=C)CC2)CC1] |
| 3-4 | 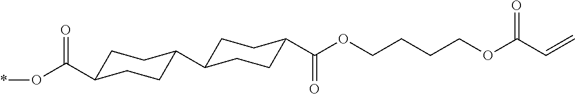 [SMILES: *OC(=O)C1CCC(C2CCC(C(=O)OCCCCOC(=O)C=C)CC2)CC1] |
| 3-5 | 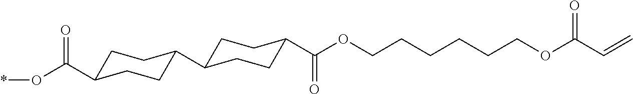 [SMILES: *OC(=O)C1CCC(C2CCC(C(=O)OCCCCCCOC(=O)C=C)CC2)CC1] |
| 3-6 | 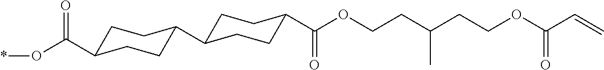 [SMILES: *OC(=O)C1CCC(C2CCC(C(=O)OCCC(C)CCOC(=O)C=C)CC2)CC1] |
| 3-7 | 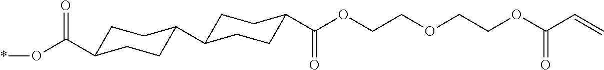 [SMILES: *OC(=O)C1CCC(C2CCC(C(=O)OCCOCCOC(=O)C=C)CC2)CC1] |
| 3-8 | 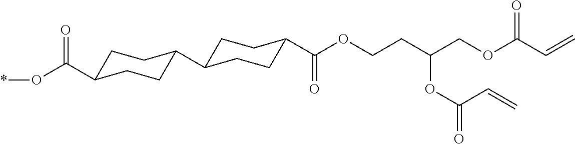 [SMILES: *OC(=O)C1CCC(C2CCC(C(=O)OCCC(COC(=O)C=C)OC(=O)C=C)CC2)CC1] |
| 3-9 | 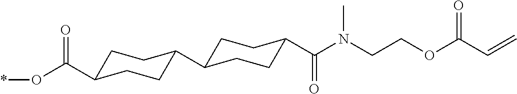 [SMILES: *OC(=O)C1CCC(C2CCC(C(=O)N(C)CCOC(=O)C=C)CC2)CC1] |
| 3-10 | 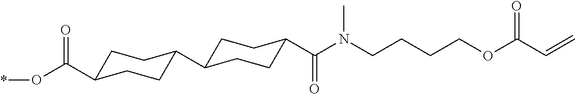 [SMILES: *OC(=O)C1CCC(C2CCC(C(=O)N(C)CCCCOC(=O)C=C)CC2)CC1] |
| 3-11 | 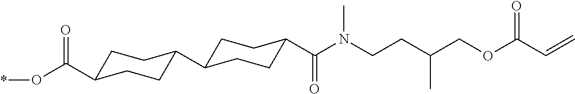 [SMILES: *OC(=O)C1CCC(C2CCC(C(=O)N(C)CCC(C)COC(=O)C=C)CC2)CC1] |
| 3-12 | 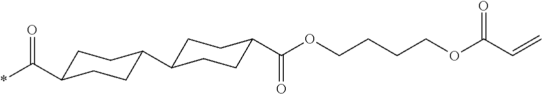 [SMILES: *C(=O)C1CCC(C2CCC(C(=O)OCCCCOC(=O)C=C)CC2)CC1] |
| 3-13 | 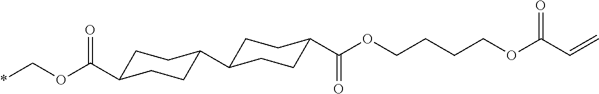 [SMILES: *COC(=O)C1CCC(C2CCC(C(=O)OCCCCOC(=O)C=C)CC2)CC1] |
| 3-14 | 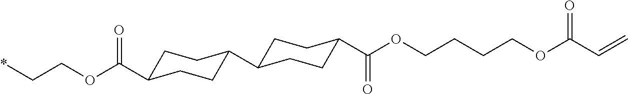 [SMILES: *CCOC(=O)C1CCC(C2CCC(C(=O)OCCCCOC(=O)C=C)CC2)CC1] |

TABLE 4

| | Side chain structure |
|---|---|
| | -D⁷-C(═O)-Cy²-Cy¹-C(═O)-D⁹-SP⁵-L⁵ |
| 4-1 | 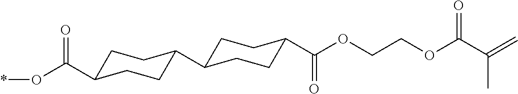 [SMILES: *OC(=O)C1CCC(C2CCC(C(=O)OCCOC(=O)C(=C)C)CC2)CC1] |
| 4-2 | 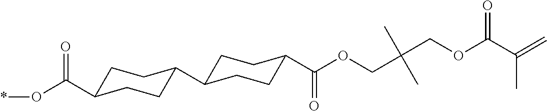 [SMILES: *OC(=O)C1CCC(C2CCC(C(=O)OCC(C)(C)COC(=O)C(=C)C)CC2)CC1] |
| 4-3 | 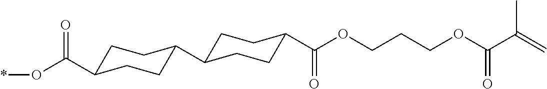 [SMILES: *OC(=O)C1CCC(C2CCC(C(=O)OCCCOC(=O)C(=C)C)CC2)CC1] |
| 4-4 | 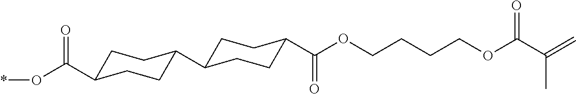 [SMILES: *OC(=O)C1CCC(C2CCC(C(=O)OCCCCOC(=O)C(=C)C)CC2)CC1] |
| 4-5 | 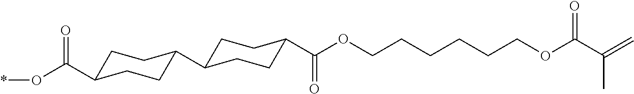 [SMILES: *OC(=O)C1CCC(C2CCC(C(=O)OCCCCCCOC(=O)C(=C)C)CC2)CC1] |
| 4-6 | 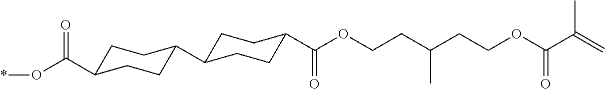 [SMILES: *OC(=O)C1CCC(C2CCC(C(=O)OCCC(C)CCOC(=O)C(=C)C)CC2)CC1] |
| 4-7 | 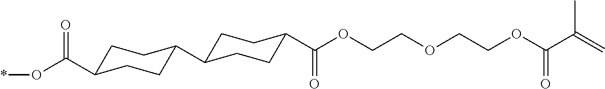 [SMILES: *OC(=O)C1CCC(C2CCC(C(=O)OCCOCCOC(=O)C(=C)C)CC2)CC1] |
| 4-8 | 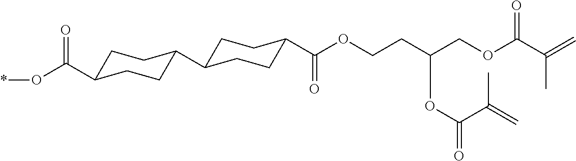 [SMILES: *OC(=O)C1CCC(C2CCC(C(=O)OCCC(COC(=O)C(=C)C)OC(=O)C(=C)C)CC2)CC1] |
| 4-9 | 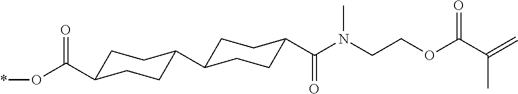 [SMILES: *OC(=O)C1CCC(C2CCC(C(=O)N(C)CCOC(=O)C(=C)C)CC2)CC1] |
| 4-10 | 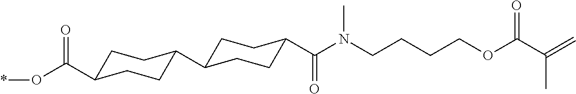 [SMILES: *OC(=O)C1CCC(C2CCC(C(=O)N(C)CCCCOC(=O)C(=C)C)CC2)CC1] |
| 4-11 | 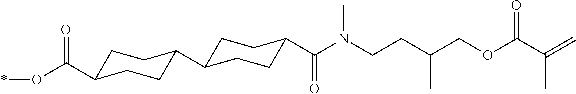 [SMILES: *OC(=O)C1CCC(C2CCC(C(=O)N(C)CCC(C)COC(=O)C(=C)C)CC2)CC1] |
| 4-12 | 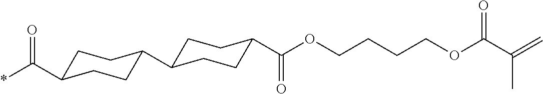 [SMILES: *C(=O)C1CCC(C2CCC(C(=O)OCCCCOC(=O)C(=C)C)CC2)CC1] |
| 4-13 | 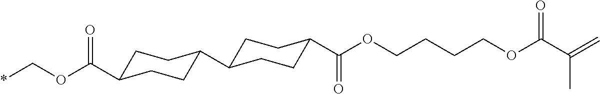 [SMILES: *COC(=O)C1CCC(C2CCC(C(=O)OCCCCOC(=O)C(=C)C)CC2)CC1] |
| 4-14 | 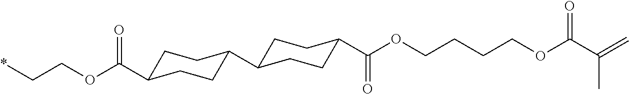 [SMILES: *CCOC(=O)C1CCC(C2CCC(C(=O)OCCCCOC(=O)C(=C)C)CC2)CC1] |

Furthermore, in the present invention, from the viewpoint of exhibiting liquid crystallinity, the polymerizable compound represented by Formula (II) is preferably a polymerizable compound in which A⁵ in Formula (II) represents any one ring structure selected from the group consisting of the groups represented by Formulae (A5-1) to (A5-5).

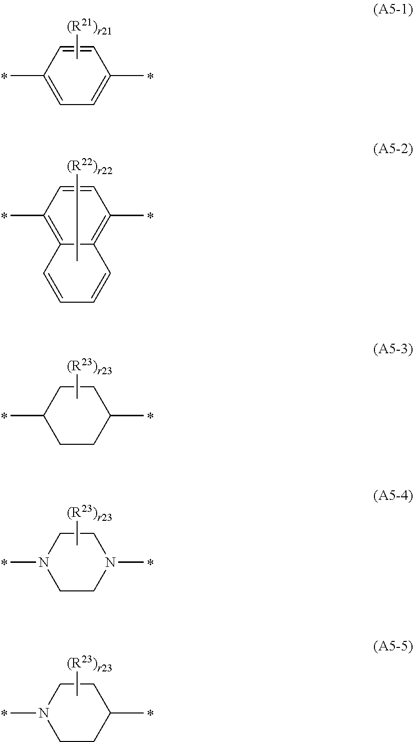

In Formulae (A5-1) to (A5-5), * represents a bonding position to D⁷ or D⁸. In a case where the polymerizable compound represented by Formula (II) is a polymerizable compound represented by Formula (IIa), the bonding position to D⁸ becomes the bonding position to D¹¹.

Furthermore, R²¹ represents a substituent, and r²¹ represents an integer of 0 to 4, and is preferably an integer of 0 to 2, and more preferably 0 or 1.

Moreover, R²² represents a substituent, and r²² represents an integer of 0 to 6, and is preferably an integer of 0 to 2, and more preferably 0 or 1.

In addition, R²³ represents an alkyl group having 1 to 5 carbon atoms, and r²³ represents an integer of 0 to 8, and is preferably an integer of 0 to 4, more preferably an integer of 0 to 2, and still more preferably 0 or 1.

Examples of the substituent represented by each of R²¹ in Formula (A5-1) and R²² in Formula (A5-2) include an alkyl group, an alkoxy group, a halogen atom, a cyano group, an alkoxycarbonyl group, an aryl group, a formyl group, and an alkylcarbonyl group.

As the alkyl group, for example, a linear, branched, or cyclic alkyl group having 1 to 18 carbon atoms is preferable, an alkyl group having 1 to 8 carbon atoms (for example, a methyl group, an ethyl group, a propyl group, an isopropyl group, an n-butyl group, an isobutyl group, a sec-butyl group, a t-butyl group, and a cyclohexyl group) is more preferable, an alkyl group having 1 to 4 carbon atoms is still more preferable, and the methyl group or the ethyl group is particularly preferable.

As the alkoxy group, for example, an alkoxy group having 1 to 18 carbon atoms is preferable, an alkoxy group having 1 to 8 carbon atoms (for example, a methoxy group, an ethoxy group, an n-butoxy group, and a methoxy ethoxy group) is more preferable, an alkoxy group having 1 to 4 carbon atoms is still more preferable, and the methoxy group or the ethoxy group is particularly preferable.

Examples of the halogen atom include a fluorine atom, a chlorine atom, a bromine atom, and an iodine atom, and among these, the fluorine atom or the chlorine atom is preferable.

Examples of the alkoxycarbonyl group include a substituted or unsubstituted alkoxycarbonyl group, and as the unsubstituted alkoxycarbonyl group, for example, an alkoxycarbonyl group having 1 to 18 carbon atoms is preferable, and an alkoxycarbonyl group having 1 to 8 carbon atoms (for example, a methoxycarbonyl group, an ethoxycarbonyl group, and an n-butoxycarbonyl group) is more preferable. As the substituted alkoxycarbonyl group, for example, an alkoxycarbonyl group substituted by a polymerizable group such as an acryloxybutoxycarbonyl group is preferable.

Examples of the aryl group include a substituted or unsubstituted phenyl group, and a disubstituted or unsubstituted naphthyl group, and the aryl group is preferably an aryl group having 6 to 12 carbon atoms (in particular, a phenyl group).

Examples of the alkylcarbonyl group include a substituted or unsubstituted alkylcarbonyl group having 2 to 10 carbon atoms, and the alkylcarbonyl group is preferably, for example, an acetyl group.

In Formulae (A5-3) to (A5-5), specific examples of the alkyl group having 1 to 5 carbon atoms represented by R²³ include a methyl group, an ethyl group, a propyl group, an isopropyl group, and an n-butyl group.

Specific examples of the groups represented by Formulae (A5-1) to (A5-5) include groups shown below. In the groups shown below, * represents a bonding position to D⁷ or D⁸.

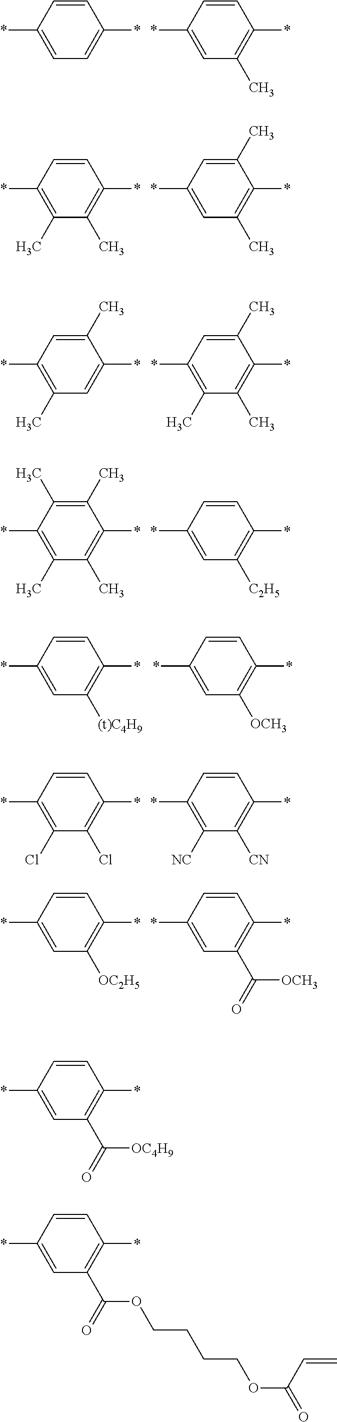

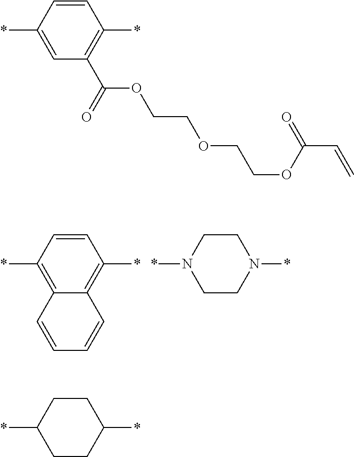

In Formula (II), examples of the side chain structure on the right side of A⁵, that is, -D⁸-(A⁶-D¹⁰)ₙ-SP⁶-L⁶, include side chain structures 5-1 to 5-15 shown in Table 5 below.

Furthermore, in Table 5 below, “*” shown in the side chain structure represents a bonding position to A⁵.

TABLE 5

| | Side chain structure |
|---|---|
| | -D⁸-(A⁶-D¹⁰)ₙ-SP⁶-L⁶ |
| 4-1 | 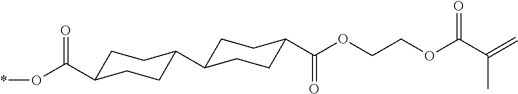 [SMILES: *OC(=O)C1CCC(C2CCC(C(=O)OCCOC(=O)C(=C)C)CC2)CC1] |
| 4-2 | 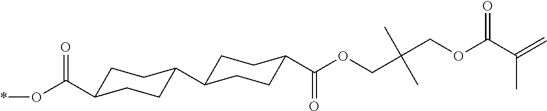 [SMILES: *OC(=O)C1CCC(C2CCC(C(=O)OCC(C)(C)COC(=O)C(=C)C)CC2)CC1] |
| 4-3 | 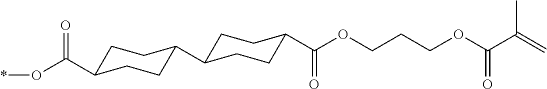 [SMILES: *OC(=O)C1CCC(C2CCC(C(=O)OCCCOC(=O)C(=C)C)CC2)CC1] |
| 4-4 | 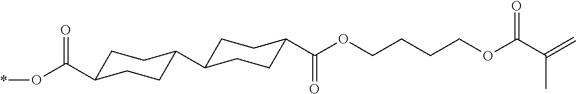 [SMILES: *OC(=O)C1CCC(C2CCC(C(=O)OCCCCOC(=O)C(=C)C)CC2)CC1] |
| 4-5 | 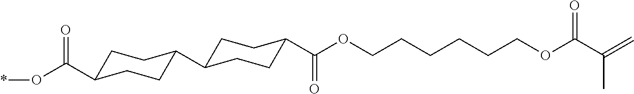 [SMILES: *OC(=O)C1CCC(C2CCC(C(=O)OCCCCCCOC(=O)C(=C)C)CC2)CC1] |
| 4-6 | 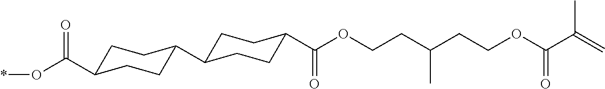 [SMILES: *OC(=O)C1CCC(C2CCC(C(=O)OCCC(C)CCOC(=O)C(=C)C)CC2)CC1] |
| 4-7 | 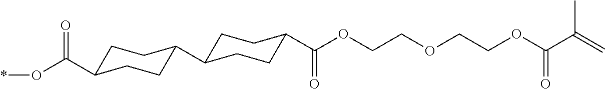 [SMILES: *OC(=O)C1CCC(C2CCC(C(=O)OCCOCCOC(=O)C(=C)C)CC2)CC1] |
| 4-8 | 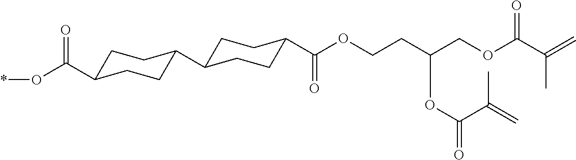 [SMILES: *OC(=O)C1CCC(C2CCC(C(=O)OCCC(COC(=O)C(=C)C)OC(=O)C(=C)C)CC2)CC1] |
| 4-9 | 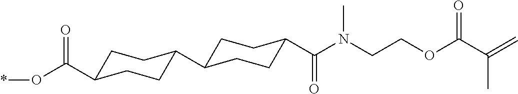 [SMILES: *OC(=O)C1CCC(C2CCC(C(=O)N(C)CCOC(=O)C(=C)C)CC2)CC1] |
| 4-10 | 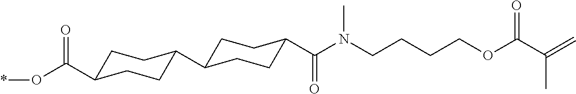 [SMILES: *OC(=O)C1CCC(C2CCC(C(=O)N(C)CCCCOC(=O)C(=C)C)CC2)CC1] |
| 4-11 | 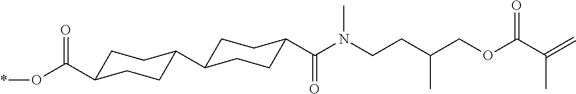 [SMILES: *OC(=O)C1CCC(C2CCC(C(=O)N(C)CCC(C)COC(=O)C(=C)C)CC2)CC1] |
| 4-12 | 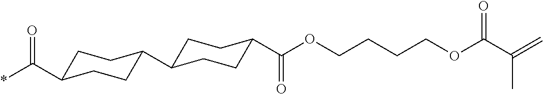 [SMILES: *C(=O)C1CCC(C2CCC(C(=O)OCCCCOC(=O)C(=C)C)CC2)CC1] |
| 4-13 | 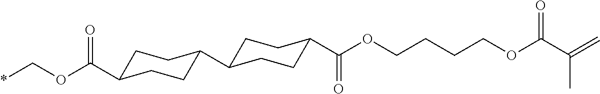 [SMILES: *COC(=O)C1CCC(C2CCC(C(=O)OCCCCOC(=O)C(=C)C)CC2)CC1] |
| 4-14 | 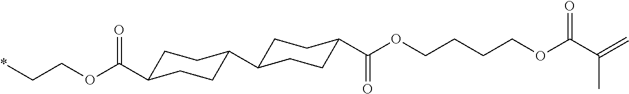 [SMILES: *CCOC(=O)C1CCC(C2CCC(C(=O)OCCCCOC(=O)C(=C)C)CC2)CC1] |

In Formula (IIa), examples of the side chain structure on the right side of A⁵, that is, -D¹¹-C(═O)-Cy³-Cy⁴-C(═O)-D¹²-SP⁶-L⁶ include the same side chain structures as the above-mentioned side chain structures 3-1 to 3-14 and 4-1 to 4-14 shown in Tables 3 and 4, and side chain structures 6-1 to 6-4 shown in Table 6 below.

Here, in a case where the side chain structure on the right side of A⁵ is the same side chain structure as the above-mentioned side chain structures 3-1 to 3-14 and 4-1 to 4-14 shown in Tables 3 and 4, the polymerizable compound represented by Formula (IIa) is a polymerizable compound having a symmetric side chain structure around A⁵.

Furthermore, in Table 6 below, “*” shown in the side chain structure represents a bonding position to A⁵.

TABLE 6

| | Side chain structure |
|---|---|
| | -D¹¹-C(═O)-Cy³-Cy⁴-C(═O)-D¹²-SP⁶-L⁶ |
| 6-1 | 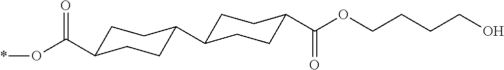 [SMILES: *OC(=O)C1CCC(C2CCC(C(=O)OCCCCO)CC2)CC1] |
| 6-2 | 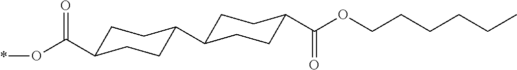 [SMILES: *OC(=O)C1CCC(C2CCC(C(=O)OCCCCCC)CC2)CC1] |
| 6-3 | 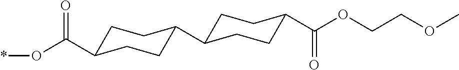 [SMILES: *OC(=O)C1CCC(C2CCC(C(=O)OCCOC)CC2)CC1] |
| 6-4 | 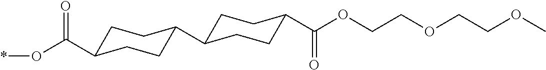 [SMILES: *OC(=O)C1CCC(C2CCC(C(=O)OCCOCCOC)CC2)CC1] |

Examples of the polymerizable compound (II) represented by Formula (II) include compounds obtained by appropriate combination of any one ring structure (A¹) selected from the group consisting of the above-mentioned groups represented by Formulae (A5-1) to (A5-5), a side chain structure (the left side chain of A⁵) selected from the above-mentioned side chain structures 3-1 to 3-14 and 4-1 to 4-14 shown in Tables 3 and 4, and the same side chain structure (the right side chain of A⁵) as the above-mentioned side chain structures 5-1 to 5-14 shown in Table 5, the above-mentioned side chain structures 6-1 to 6-4 shown in Table 6, and the above-mentioned side chain structures 3-1 to 3-14 and 4-1 to 4-14 shown in Tables 3 and 4.

Among the examples of the polymerizable compound (II) consisting of these combinations, a compound represented by the following formula is preferable. Further, in the following formula, R represents a methyl group, a tert-butyl group, a methoxy group, or a fluorine atom, and m represents an integer of 0 to 3.

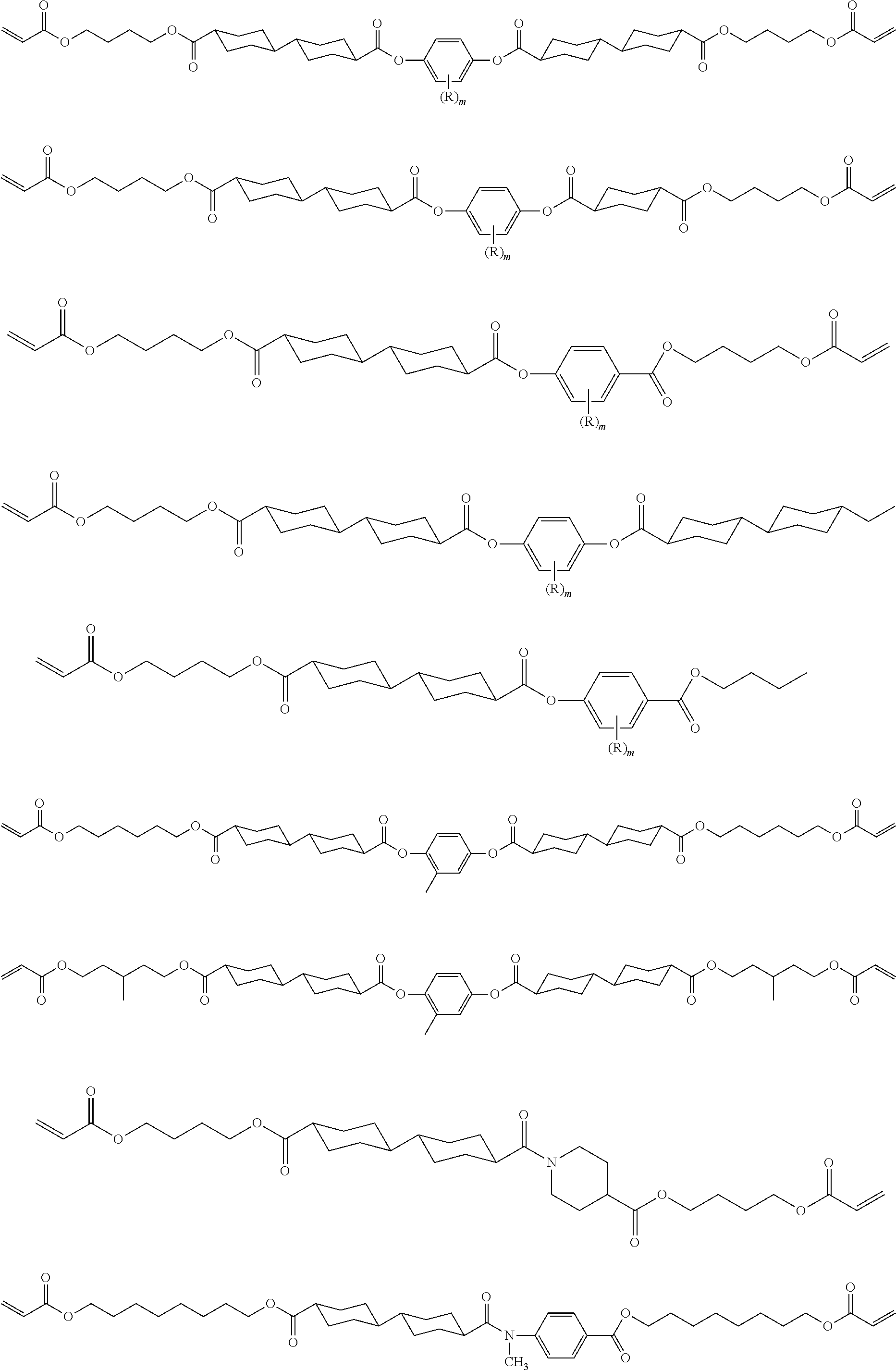

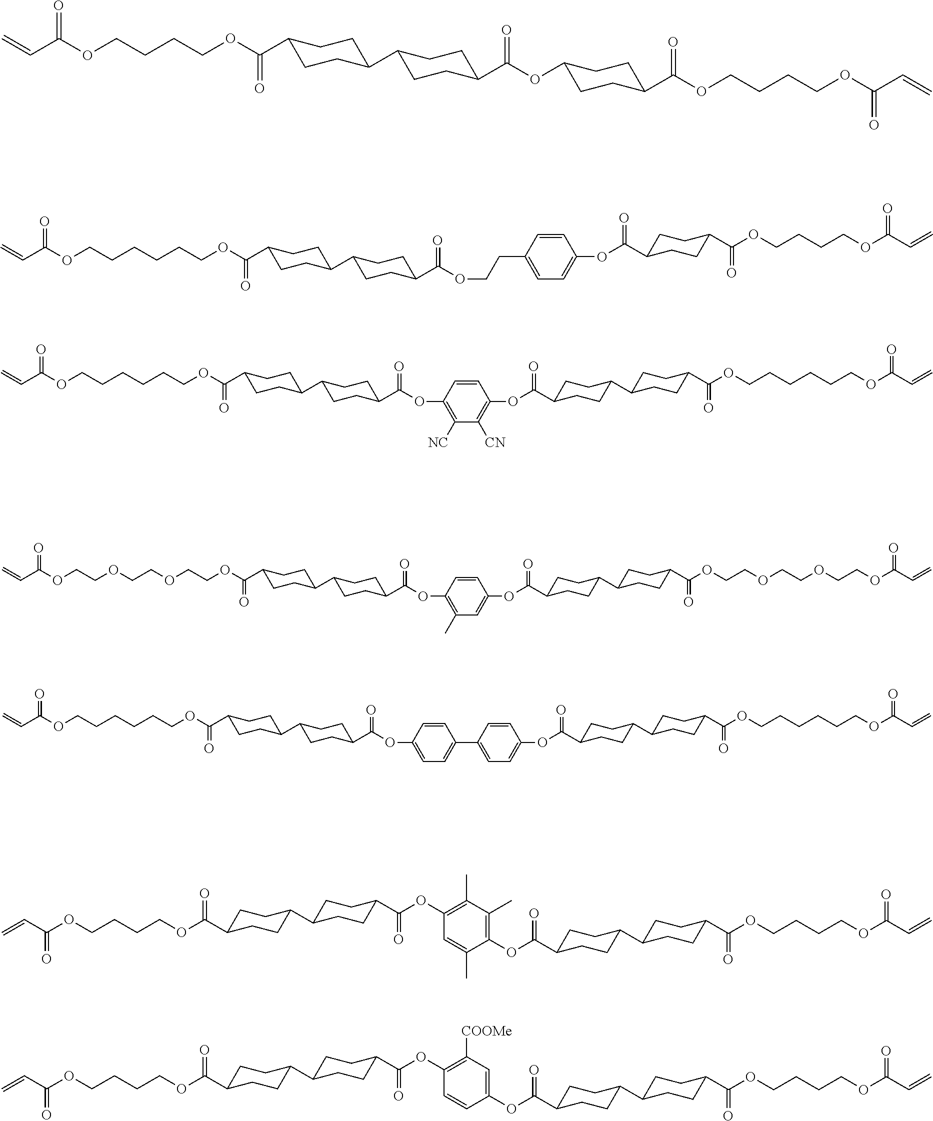

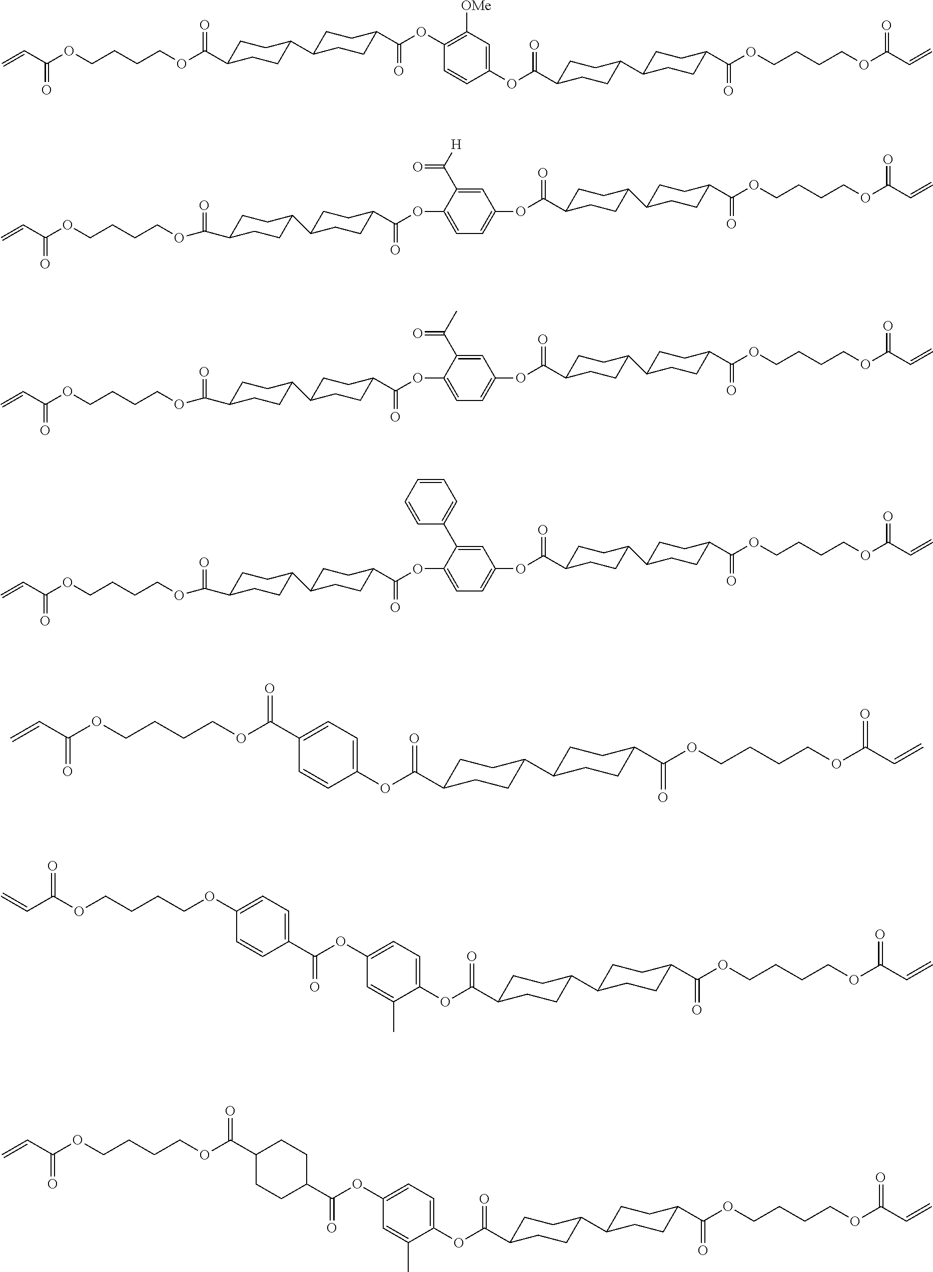

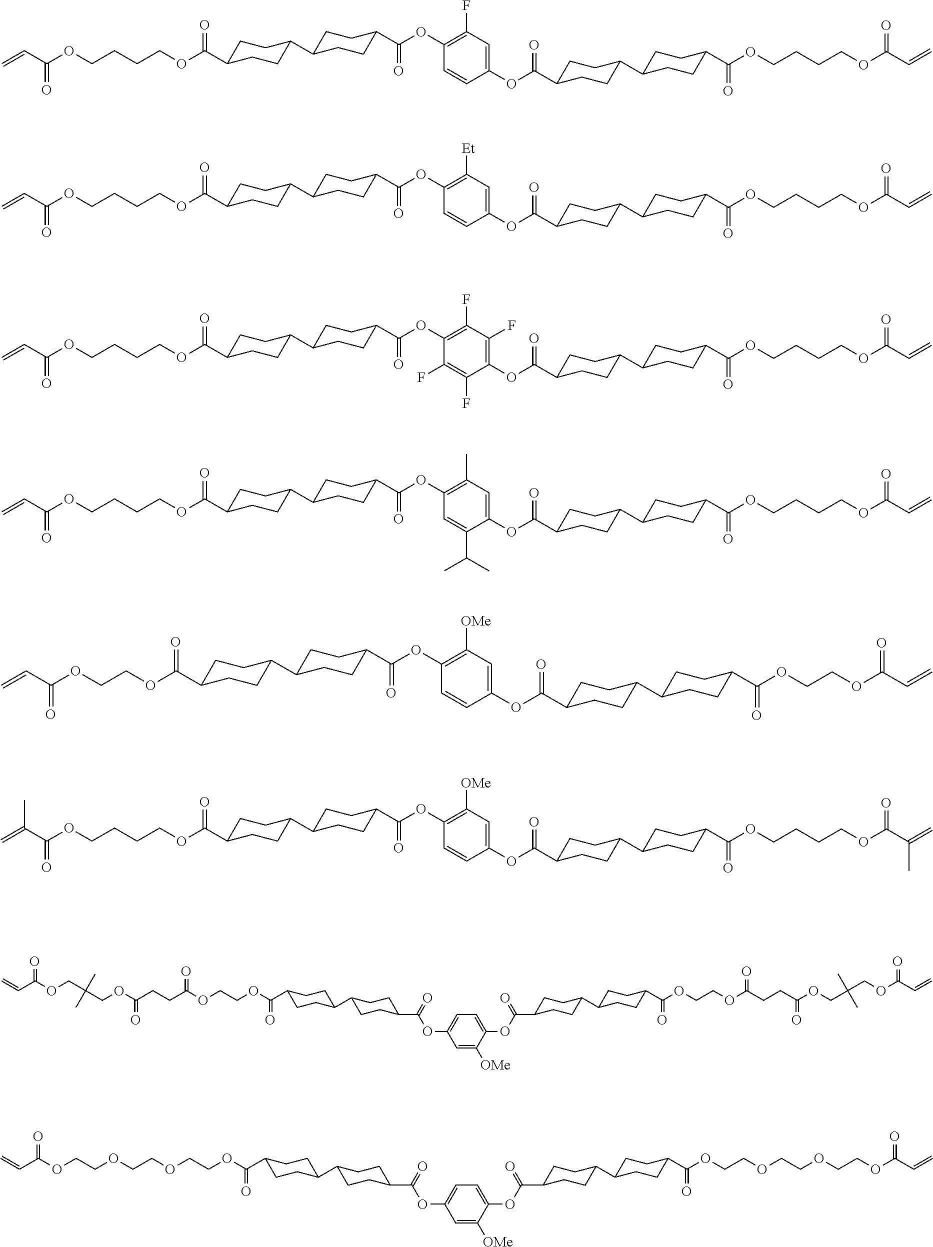

In the present invention, the content of the polymerizable compound (II) is preferably 0.5 to 100 parts by mass, more preferably 1 to 50 parts by mass, and still more preferably 2 to 40 parts by mass, with respect to 100 parts by mass of the above-mentioned polymerizable liquid crystal compound (I).

[Other Polymerizable Compounds]

The polymerizable liquid crystal composition of the embodiment of the present invention may include other polymerizable compounds having one or more polymerizable groups, in addition to the above-mentioned polymerizable liquid crystal compound (I) and polymerizable compound (II).

Here, the polymerizable group which such other polymerizable compounds have is not particularly limited, and examples thereof include an acryloyl group, a methacryloyl group, a vinyl group, a styryl group, and an allyl group. Among those, such other polymerizable compounds preferably have the acryloyl group or the methacryloyl group.

For a reason that the moisture-heat resistance of an optically anisotropic film thus formed is further improved, such other polymerizable compounds are preferably other polymerizable compounds having 1 to 4 polymerizable groups, and more preferably other polymerizable compounds having 2 polymerizable groups.

Examples of such other polymerizable compounds include the compounds described in paragraphs [0073] and [0074] of JP2016-053709A.

Furthermore, other examples of such other polymerizable compounds include the compounds represented by Formulae (M1), (M2), and (M3) described in paragraphs [0030] to [0033] of JP2014-077068A, and more specifically, the specific examples described in paragraphs [0046] to [0055] of the same publication.

In addition, as such other polymerizable compounds, the compounds having the structures of Formulae (1) to (3) described in JP2014-198814A can also be preferably used, and more specifically, examples of such other polymerizable compounds include the specific examples described in paragraphs [0020] to [0035], [0042] to [0050], [0056], and [0057] of the same publication.

In a case where such other polymerizable compounds are contained, a content thereof is preferably less than 50% by mass, more preferably 40% by mass or less, and still more preferably 2% to 30% by mass, with respect to a total mass including the above-mentioned polymerizable liquid crystal compound (I) and polymerizable compound (II).

[Polymerization Initiator]

The polymerizable liquid crystal composition of the embodiment of the present invention preferably contains a polymerization initiator.

The polymerization initiator to be used is preferably a photopolymerization initiator capable of initiating a polymerization reaction upon irradiation with ultraviolet rays.

Examples of the photopolymerization initiator include α-carbonyl compounds (described in each of the specifications of U.S. Pat. Nos. 2,367,661A and 2,367,670A), acyloin ethers (described in the specification of U.S. Pat. No. 2,448,828A), α-hydrocarbon-substituted aromatic acyloin compounds (described in the specification of U.S. Pat. No. 2,722,512A), multinuclear quinone compounds (described in each of the specifications of U.S. Pat. Nos. 3,046,127A and 2,951,758A), combinations of a triaryl imidazole dimer and a p-aminophenyl ketone (described in the specification of U.S. Pat. No. 3,549,367A), acridine and phenazine compounds (described in JP1985-105667A (JP-S60-105667A) and the specification of U.S. Pat. No. 4,239,850A), oxadiazole compounds (described in the specification of U.S. Pat. No. 4,212,970A), and acyl phosphine oxide compounds (described in JP1988-040799B (JP-S63-040799B), JP1993-029234B (JP-H05-029234B), JP1998-095788A (JP-H10-095788A), and JP1998-029997A (JP-H10-029997A)).

In addition, in the present invention, it is also preferable that the polymerization initiator is an oxime-type polymerization initiator, and specific examples thereof include the initiators described in paragraphs [0049] to [0052] of WO2017/170443A.

[Solvent]

It is preferable that the polymerizable liquid crystal composition of the embodiment of the present invention contains a solvent from the viewpoint of workability for forming an optically anisotropic film, and the like.

Specific examples of the solvent include ketones (for example, acetone, 2-butanone, methyl isobutyl ketone, cyclohexanone, and cyclopentanone), ethers (for example, dioxane and tetrahydrofuran), aliphatic hydrocarbons (for example, hexane), alicyclic hydrocarbons (for example, cyclohexane), aromatic hydrocarbons (for example, toluene, xylene, and trimethylbenzene), halogenated carbons (for example, dichloromethane, dichloroethane, dichlorobenzene, and chlorotoluene), esters (for example, methyl acetate, ethyl acetate, and butyl acetate), water, alcohols (for example, ethanol, isopropanol, butanol, and cyclohexanol), cellosolves (for example, methyl cellosolve and ethyl cellosolve), cellosolve acetates, sulfoxides (for example, dimethyl sulfoxide), and amides (for example, dimethyl formamide and dimethylacetamide), and these may be used singly or in combination of two or more kinds thereof.

[Leveling Agent]

It is preferable that the polymerizable liquid crystal composition of the embodiment of the present invention contains a leveling agent from the viewpoint that the surface of an optically anisotropic film is maintained smooth and the alignment is easily controlled.

Such the leveling agent is preferably a fluorine-based leveling agent or a silicon-based leveling agent for a reason that it has a high leveling effect on the addition amount, and the leveling agent is more preferably a fluorine-based leveling agent from the viewpoint that it is less likely to cause bleeding (bloom or bleed).

Specific example of the leveling agent include the compounds described in paragraphs [0079] to [0102] of JP2007-069471A, the compound represented by General Formula (I) described in JP2013-047204A (in particular, the compounds described in paragraphs [0020] to [0032]), the compound represented by General Formula (I) described in JP2012-211306A (in particular, the compounds described in paragraphs [0022] to [0029]), the liquid crystal alignment accelerator represented by General Formula (I) described in JP2002-129162A (in particular, the compounds described in paragraphs [0076] to [0078] and [0082] to [0084]), and the compounds represented by General Formulae (I), (II), and (III) described in 22005-099248A (in particular, the compounds described in paragraphs [0092] to [0096]). In addition, the leveling agent may also function as an alignment control agent which will be described later.

[Alignment Control Agent]

The polymerizable liquid crystal composition of the embodiment of the present invention can contain an alignment control agent, as desired.

With the alignment control agent, various alignment states such as homeotropic alignment (vertical alignment), tilt alignment, hybrid alignment, and cholesteric alignment can be formed, in addition to the homogeneous alignment, and specific alignment states can be controlled and achieved more uniformly and more accurately.

As an alignment control agent which accelerates the homogeneous alignment, for example, a low-molecular-weight alignment control agent or a high-molecular-weight alignment control agent can be used.

With regard to the low-molecular-weight alignment control agent, reference can be made to the description in, for example, paragraphs [0009] to [0083] of JP2002-020363A, paragraphs [0111] to [0120] of JP2006-106662A, and paragraphs [0021] to [0029] of JP2012-211306A, the contents of which are hereby incorporated by reference.

In addition, with regard to the high-molecular-weight alignment control agent, reference can be made to the description in, for example, paragraphs [0021] to [0057] of JP2004-198511A and paragraphs [0121] to [0167] of JP2006-106662A, the contents of which are hereby incorporated by reference.

Furthermore, examples of the alignment control agent that forms or accelerates the homeotropic alignment include a boronic acid compound and an onium salt compound, and specifically, reference can be made to the compounds described in paragraphs [0023] to [0032] of JP2008-225281A, paragraphs [0052] to [0058] of JP2012-208397A, paragraphs [0024] to [0055] of JP2008-026730A, paragraphs [0043] to [0055] of JP2016-193869A, and the like, the contents of which are hereby incorporated by reference.

On the other hand, the cholesteric alignment can be achieved by adding a chiral agent to the polymerizable liquid crystal composition of the embodiment of the present invention, and it is possible to control the direction of revolution of the cholesteric alignment by its chiral direction. Incidentally, it is possible to control the pitch of the cholesteric alignment in accordance with the alignment regulating force of the chiral agent.

In a case where an alignment control agent is contained, a content thereof is preferably 0.01% to 10% by mass, and more preferably 0.05% to 5% by mass, with respect to the mass of the total solid content of the polymerizable liquid crystal composition. In a case where the content is within the range, it is possible to obtain an optically anisotropic film which has no precipitation or phase separation, alignment defects, or the like, and is homogeneous and highly transparent while achieving a desired alignment state.

These alignment control agents can further impart a polymerizable functional group, in particular, a polymerizable functional group which is polymerizable with a polymerizable liquid crystal compound constituting the polymerizable liquid crystal composition of the embodiment of the present invention.

[Other Components]

The polymerizable liquid crystal composition of the embodiment of the present invention may contain components other than the above-mentioned components, and examples of such other components include a liquid crystal compound other than the above-mentioned polymerizable liquid crystal compound, a surfactant, a tilt angle control agent, an alignment aid, a plasticizer, and a crosslinking agent.

[Optically Anisotropic Film]

An optically anisotropic film of an embodiment of the present invention is an optically anisotropic film obtained by polymerizing the above-mentioned polymerizable liquid crystal composition of the embodiment of the present invention.

Examples of a method for forming the optically anisotropic film include a method in which the above-mentioned polymerizable liquid crystal composition of the embodiment of the present invention is used to form a desired alignment state, which is then fixed by polymerization.

Here, the polymerization conditions are not particularly limited, but in the polymerization by irradiation with light, ultraviolet rays are preferably used. The irradiation dose is preferably 10 mJ/cm² to 50 J/cm², more preferably 20 mJ/cm² to 5 J/cm², still more preferably 30 mJ/cm² to 3 J/cm², and particularly preferably 50 mJ/cm² to 1,000 mJ/cm². In addition, the polymerization may be carried out under a heating condition in order to accelerate the polymerization reaction.

In addition, in the present invention, the optically anisotropic film can be formed on any of supports in the optical film of the embodiment of the present invention which will be described later or a polarizer in the polarizing plate of an embodiment of the present invention which will be described later.

The optically anisotropic film of the embodiment of the present invention preferably satisfies the following Formula (III).

0.50<Re(450)/Re(550)<1.00 (III)

Here, in Formula (III), Re(450) represents an in-plane retardation of the optically anisotropic film at a wavelength of 450 nm, and Re(550) represents an in-plane retardation of the optically anisotropic film at a wavelength of 550 nm. In addition, in the present specification, in a case where the measurement wavelength of the retardation is not specified, the measurement wavelength is 550 nm.

Furthermore, the values of the in-plane retardation and the thickness-direction retardation refer to values measured with light at the measurement wavelength using AxoScan OPMF-1 (manufactured by Opto Science, Inc.).

Specifically, by inputting the average refractive index ((Nx+Ny+Nz)/3) and the film thickness (d (μm)) to AxoScan OPMF-1, it is possible to calculate:

Slow axis direction (°)

Re(λ)−R0(λ)

Rth(λ)=((nx+ny)/2−nz)×d.

In addition, R0(λ) is expressed in a numerical value calculated with AxoScan OPMF-1, but means Re(λ).

The optically anisotropic film of the embodiment of the present invention is preferably a positive A-plate or a positive C-plate, and more preferably the positive A-plate.

Here, the positive A-plate (A-plate which is positive) and the positive C-plate (C-plate which is positive) are defined as follows.

In a case where a refractive index in a film in-plane slow axis direction (in a direction in which an in-plane refractive index is maximum) is defined as nx, a refractive index in an in-plane direction perpendicular to the in-plane slow axis is defined as ny, and a refractive index in a thickness direction is defined as nz, the positive A-plate satisfies the relationship of Formula (A1) and the positive C-plate satisfies the relationship of Formula (C1). In addition, the positive A-plate has an Rth showing a positive value and the positive C-plate has an Rth showing a negative value.

nx>ny≈nz Formula (A1)

nz>nx≈ny Formula (C1)

Furthermore, the symbol, “≈”, encompasses not only a case where the both are completely the same as each other but also a case where the both are substantially the same as each other.

The expression, “substantially the same”, means that with regard to the positive A-plate, for example, a case where (ny−nz)×d (in which d is the thickness of a film) is −10 to 10 nm, and preferably −5 to 5 nm is also included in “ny≈mz”, and a case where (nx−nz)×d is −10 to 10 nm, and preferably −5 to 5 nm is also included in “nx≈nz”. In addition, with regard to the positive C-plate, for example, a case where (nx−ny)×d (in which d is the thickness of a film) is 0 to 10 nm, and preferably 0 to 5 nm is also included in “nx≈ny”.

In a case where the optically anisotropic film of the embodiment of the present invention is a positive A-plate, the Re(550) is preferably 100 to 180 nm, more preferably 120 to 160 nm, still more preferably 130 to 150 nm, and particularly preferably 130 to 140 nm, from the viewpoint that the optically anisotropic film functions as a λ/4 plate.

Here, the “λ/4 plate” is a plate having a λ/4 function, specifically, a plate having a function of converting a linearly polarized light at a certain specific wavelength into a circularly polarized light (or converting a circularly polarized light to a linearly polarized light).

[Optical Film]

The optical film of the embodiment of the present invention is an optical film having the optically anisotropic film of the embodiment of the present invention.

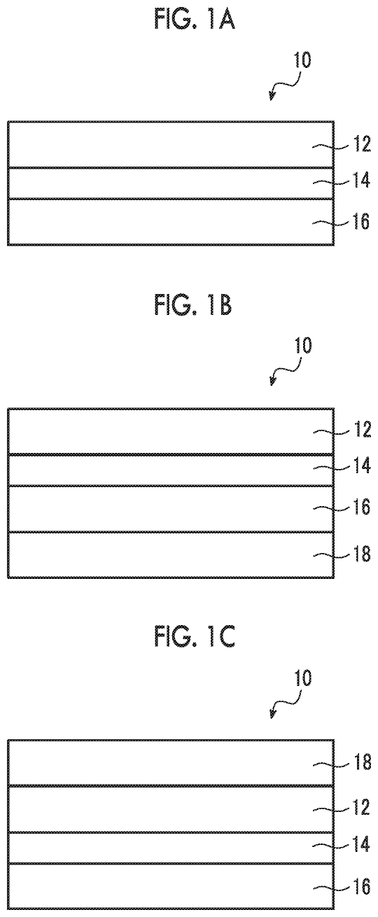

FIG. 1A, FIG. 1B, and FIG. 1C (these drawings are hereinafter simply referred to as “FIG. 1” unless it is necessary that they are particularly distinguished from each other) are each a schematic cross-sectional view showing an example of the optical film of the embodiment of the present invention.

Furthermore, FIG. 1 is a schematic view, and the thicknesses relationship, the positional relationship, and the like among the respective layers are not necessarily consistent with actual ones, and any of the support, the alignment film, and the hard coat layer shown in FIG. 1 are optional constitutional members.

An optical film 10 shown in FIG. 1 has a support 16, an alignment film 14, and an optically anisotropic film 12 in this order.

In addition, the optical film 10 may have a hard coat layer 18 on the side of the support 16 opposite to the side on which the alignment film 14 is provided as shown in FIG. 1B, and may have the hard coat layer 18 on the side of the optically anisotropic film 12 opposite to the side on which the alignment film 14 is provided as shown in FIG. 1C.

Hereinafter, various members used for the optical film of the embodiment of the present invention will be described in detail.

[Optically Anisotropic Film]

The optically anisotropic film which the optical film of die embodiment of the present invention has is the above-mentioned optically anisotropic film of the embodiment of the present invention.

In the optical film of the embodiment of the present invention, the thickness of the optically anisotropic film is not particularly limited, but is preferably 0.1 to 10 μm, and more preferably 0.5 to 5 μm.

[Support]

The optical film of the embodiment of the present invention may have a support as a base material for forming an optically anisotropic film as described above.

Such a support is preferably transparent, and specifically, the support preferably has a light transmittance of 80% or more.

Examples of such a support include a glass substrate and a polymer film, and examples of the material for the polymer film include cellulose-based polymers; acrylic polymers having acrylic ester polymers such as polymethyl methacrylate and a lactone ring-containing polymer; thermoplastic norbornene-based polymers; polycarbonate-based polymers; polyester-based polymers such as polyethylene terephthalate and polyethylene naphthalate; styrene-based polymers such as polystyrene and an acrylonitrile-styrene copolymer (AS resin); polyolefin-based polymers such as polyethylene, polypropylene, and an ethylene-propylene copolymer, vinyl chloride-based polymers; amide-based polymers such as nylon and aromatic polyamide; imide-based polymers; sulfone-based polymers; polyether sulfone-based polymers; polyether ether ketone-based polymers; polyphenylene sulfide-based polymers; vinyl idene chloride-based polymers; vinyl alcohol-based polymers; vinyl butyral-based polymers; arylate-based polymers; polyoxymethylene-based polymers; epoxy-based polymers; and polymers obtained by mixing these polymers.

In addition, an aspect in which a polarizer which will be described later may also function as such a support is also available.

In the present invention, the thickness of the support is not particularly limited, but is preferably 5 to 60 μm, and more preferably 5 to 30 μm.

[Alignment Film]

In a case where the optical film of the embodiment of the present invention has any of the above-mentioned supports, it is preferable that the optical film has an alignment film between the support and the optically anisotropic film. Further, an aspect in which the above-mentioned support may also function as an alignment film is also available.

The alignment film generally has a polymer as a main component. The materials for the polymer material for an alignment film are described in many documents, and many commercially available products can be used.

The polymer material used in the present invention is preferably a polyvinyl alcohol or a polyimide, or a derivative thereof. Particularly, a modified or non-modified polyvinyl alcohol is preferable.

Examples of the alignment film that can be used in the present invention include the alignment films described for Line 24 on Page 43 to Line 8 on Page 49 of WO01/088574A; the modified polyvinyl alcohols described in paragraphs [0071] to [0095] of JP3907735B; and the liquid crystal alignment film formed by a liquid crystal aligning agent described in JP2012-155308A.

In the present invention, for a reason that it is possible to prevent deterioration in the surface condition by avoiding a contact with the surface of an alignment film upon formation of the alignment film, a photo-alignment film is also preferably used as the alignment film.

The photo-alignment film is not particularly limited, but the polymer materials such as a polyamide compound and a polyimide compound, described in paragraphs 0024 to 0043 of WO2005/096041A; the liquid crystal alignment film formed by a liquid crystal aligning agent having a photo-alignment group, described in JP2012-155308A; LPP-JP265CP, trade name, manufactured by Rolic Technologies Ltd.; or the like can be used.

In addition, in the present invention, the thickness of the alignment film is not particularly limited, but from the viewpoint of forming an optically anisotropic film having a uniform film thickness by alleviating the surface roughness that can be present on the support, the thickness is preferably 0.01 to 10 μm, more preferably 0.01 to 1 μm, and still more preferably 0.01 to 0.5 μm.

[Hard Coat Layer]

It is preferable that the optical film of the embodiment of the present invention has a hard coat layer in order to impart physical strength to the film. Specifically, the optical film may have the hard coat layer on the side of the support opposite to the side on which the alignment film is provided (see FIG. 1B) or the optical film may have the hard coat layer on the side of the optically anisotropic film opposite to the side on which the alignment film is provided (see FIG. 1C).

As the hard coat layer, those described in paragraphs [0190] to [0196] of JP2009-098658A can be used.

[Other Optically Anisotropic Films]

The optical film of the embodiment of the present invention may have other optically anisotropic films, in addition to the optically anisotropic film of the embodiment of the present invention.

That is, the optical film of the embodiment of the present invention may have a laminated structure having the optically anisotropic film of the embodiment of the present invention and other optically anisotropic films.

Such other optically anisotropic films are not particularly limited as long as the optically anisotropic films are obtained by not blending any one of the polymerizable liquid crystal compound (I) or the polymerizable compound (II), but using the above-mentioned other polymerizable compounds (in particular, liquid crystal compounds).

Here, the liquid crystal compounds can be generally classified into a rod-shaped type and a disk-shaped type according to the shape thereof. Each of the types can further be classified into a low-molecular-weight type and a high-molecular-weight type. The term, high-molecular-weight, generally refers to having a degree of polymerization of 100 or more (Polymer Physics-Phase Transition Dynamics, by Masao Doi, page 2, published by Iwanami Shoten, Publishers, 1992). In the present invention, any of the liquid crystal compounds can be used, but the rod-shaped liquid crystal compound or the discotic liquid crystal compound (disk-shaped liquid crystal compound) is preferably used. Two or more kinds of the rod-shaped liquid crystal compounds, two or more kinds of the disk-shaped liquid crystal compounds, or a mixture of the rod-shaped liquid crystal compound and the disk-shaped liquid crystal compound may be used. In order to fix the above-mentioned liquid crystal compound, it is more preferable that the liquid crystal compound is formed of a rod-shaped liquid crystal compound or disk-shaped liquid crystal compound having a polymerizable group, and it is still more preferable that the liquid crystal compound has two or more polymerizable groups in one molecule. In the case of a mixture of two or more kinds of the liquid crystal compounds, at least one kind of the liquid crystal compound preferably has two or more polymerizable groups in one molecule.

As the rod-shaped liquid crystal compound, for example, the rod-shaped liquid crystal compounds described in claim 1 of JP1999-513019A (JP-H11-513019A) or paragraphs [0026] to [0098] of JP2005-289980A can be preferably used, and as the discotic liquid crystal compound, for example, the discotic liquid crystal compounds described in paragraphs [0020] to [0067] of JP2007-108732A and paragraphs [0013] to [0108] of JP2010-244038A can be preferably used, but the liquid crystal compounds are not limited thereto.

[Ultraviolet Absorber]

The optical film of the embodiment of the present invention preferably includes an ultraviolet (UV) absorber, taking an effect of external light (particularly ultraviolet rays) into consideration.

The ultraviolet absorber may be contained in the optically anisotropic film of the embodiment of the present invention or may also be contained in a member other than an optically anisotropic film constituting the optical film of the embodiment of the present invention. Suitable examples of the member other than the optically anisotropic film include a support.

As the ultraviolet absorber, any one of ultraviolet absorbers known in the related art, which can express ultraviolet absorptivity, can be used. Among such the ultraviolet absorbers, a benzotriazole-based or hydroxyphenyltriazine-based ultraviolet absorber is preferably used from the viewpoint that it has high ultraviolet absorptivity and ultraviolet absorbing ability (ultraviolet-shielding ability) used for an image display device is obtained.

In addition, in order to broaden ultraviolet absorbing ranges, two or more of ultraviolet absorbers having different maximum absorption wavelengths can be used in combination.

Specific examples of the ultraviolet absorber include the compounds described in paragraphs [0258] and [0259] of JP2012-018395A and the compounds described in paragraphs [0055] to [0105] of JP2007-072163A.

In addition, as a commercially available product thereof, for example, Tinuvin 400, Tinuvin 405, Tinuvin 460, Tinuvin 477, Tinuvin 479, and Tinuvin 1577 (all manufactured by BASF) can be used.

[Polarizing Plate]

A polarizing plate of an embodiment of the present invention has the above-mentioned optical film of the embodiment of the present invention and a polarizer.

Furthermore, in a case where the above-mentioned optically anisotropic film of the embodiment of the present invention is a λ/4 plate (positive A-plate), the polarizing plate of the embodiment of the present invention can be used as a circularly polarizing plate.

In addition, in a case where the above-mentioned optically anisotropic film of the embodiment of the present invention is a λ/4 plate (positive A-plate), an angle between the slow axis of the λ/4 plate and the absorption axis of a polarizer which will be described later is preferably 30° to 60°, more preferably 40° to 50°, still more preferably 42° to 48°, and particularly preferably 45° in the polarizing plate of the embodiment of the present invention.

Here, the “slow axis” of the λ/4 plate means a direction in which the refractive index in the plane of the λ/4 plate becomes maximum, and the “absorption axis” of the polarizer means a direction in which the absorbance is highest.

[Polarizer]

A polarizer contained in a polarizing plate of an embodiment of the present invention is not particularly limited as long as it is a member having a function of converting light into specific linearly polarized light, and an absorptive type polarizer and a reflective type polarizer, which are known in the related art, can be used.

An iodine-based polarizer, a dye-based polarizer using a dichroic dye, a polyene-based polarizer, or the like is used as the absorptive type polarizer. The iodine-based polarizer and the dye-based polarizer are classified into a coating type polarizer and a stretching type polarizer, any of which can be applied, but a polarizer which is manufactured by allowing polyvinyl alcohol to adsorb iodine or a dichroic dye and performing stretching is preferable.

In addition, examples of a method of obtaining a polarizer by carrying out stretching and dyeing in a state of a laminated film in which a polyvinyl alcohol layer is formed on a base material include the methods disclosed in JP5048120B, JP5143918B, JP4691205B, JP4751481B, and JP4751486B, and known technologies relating to these polarizers can also be preferably used.

A polarizer in which thin films having different birefringence are laminated, a wire grid-type polarizer, a polarizer having a combination of a cholesteric liquid crystal having a selective reflection range and a ¼ wavelength plate, or the like is used as the reflective type polarizer.

Among those, a polarizer including a polyvinyl alcohol-based resin (a polymer including —CH₂—CHOH— as a repeating unit, in particular, at least one selected from the group consisting of a polyvinyl alcohol and an ethylene-vinyl alcohol copolymer) is preferable from the viewpoint that it has more excellent adhesiveness.

In the present invention, the thickness of the polarizer is not particularly limited, but is preferably 3 μm to 60 μm, more preferably 5 μm to 30 μm, and still more preferably 5 μm to 15 μm.

[Pressure-Sensitive Adhesive Layer]

The polarizing plate of the embodiment of the present invention may have a pressure-sensitive adhesive layer arranged between the optically anisotropic film in the optical film of the embodiment of the present invention and the polarizer.

The pressure-sensitive adhesive layer used for lamination of the optically anisotropic film and the polarizer represents, for example, a substance in which a ratio (tan δ=G″/G′) between a storage elastic modulus G′ and a loss elastic modulus G″, each measured with a dynamic viscoelastometer, is 0.001 to 1.5, and examples thereof include a so-called pressure-sensitive adhesive or a readily creepable substance. Examples of the pressure-sensitive adhesive that can be used in the present invention include a polyvinyl alcohol-based pressure-sensitive adhesive, but the pressure-sensitive adhesive is not limited thereto.

[Image Display Device]

An image display device of an embodiment of the present invention is an image display device having the optical film of the embodiment of the present invention or the polarizing plate of the embodiment of the present invention.

A display element used in the image display device of the embodiment of the present invention is not particularly limited, and examples thereof include a liquid crystal cell, an organic electroluminescent (hereinafter abbreviated as “EL”) display panel, and a plasma display panel.

Among those, the liquid crystal cell and the organic EL display panel are preferable, and the liquid crystal cell is more preferable. That is, as the image display device of the embodiment of the present invention, a liquid crystal display device using a liquid crystal cell as a display element or an organic EL display device using an organic EL display panel as a display element is preferable, and the liquid crystal display device is more preferable.

[Liquid Crystal Display Device]

A liquid crystal display device which is an example of the image display device of the embodiment of the present invention is a liquid crystal display device having the above-mentioned polarizing plate of the embodiment of the present invention and a liquid crystal cell.

In addition, in the present invention, it is preferable that the polarizing plate of the embodiment of the present invention is used as the polarizing plate of the front side, and it is more preferable that the polarizing plate of the embodiment of the present invention is used as the polarizing plates on the front and rear sides, among the polarizing plates provided on the both sides of the liquid crystal cell.

Hereinafter, the liquid crystal cell constituting the liquid crystal display device will be described in detail.

<Liquid Crystal Cell>

A liquid crystal cell for use in the liquid crystal display device is preferably in a vertical alignment (VA) mode, an optically compensated bend (OCB) mode, an in-plane-switching (IPS) mode, or a twisted nematic (TN) mode, but the liquid crystal cell is not limited thereto.

In a TN-mode liquid crystal cell, rod-shaped liquid crystal molecules are substantially horizontally aligned and are twist-aligned at 60° to 120° during no voltage application thereto. A TN-mode liquid crystal cell is most often used in a color TFT liquid crystal display device and described in numerous documents.

In a VA-mode liquid crystal cell, rod-shaped liquid crystal molecules are substantially vertically aligned during no voltage application thereto. Examples of the VA-mode liquid crystal cell include (1) a VA-mode liquid crystal cell in the narrow sense of the word, in which rod-shaped liquid crystal molecules are substantially vertically aligned during no voltage application thereto, but are substantially horizontally aligned during voltage application thereto (described in JP1990-176625A (JP-H02-176625A)), (2) an MVA-mode liquid crystal cell in which the VA mode is multi-domained for viewing angle enlargement (described in SID97, Digest of Tech. Papers (preprint), 28 (1997) 845), (3) a liquid crystal cell in a mode (n-ASM mode) in which rod-shaped liquid crystal molecules are substantially vertically aligned during no voltage application thereto and are multi-domain-aligned during voltage application thereto (described in Seminar of Liquid Crystals of Japan, Papers (preprint), 58-59 (1998)), and (4) a survival-mode liquid crystal cell (announced in LCD International 98). In addition, the liquid crystal cell may be of any of a patterned vertical alignment (PVA) type, an optical alignment type, and polymer-sustained alignment (PSA) type. Details of these modes are specifically described in JP2006-215326A and JP2008-538819A.

In an IPS-mode liquid crystal cell, rod-shaped liquid crystal molecules are aligned substantially parallel with respect to a substrate, and application of an electric field parallel to the substrate surface causes the liquid crystal molecules to respond planarly. The IPS mode displays black in a state where no electric field is applied and a pair of upper and lower polarizing plates have absorption axes which are orthogonal to each other. A method of improving the viewing angle by reducing light leakage during black display in an oblique direction using an optical compensation sheet is disclosed in JP1998-054982A (JP-H10-054982A), JP1999-202323A (JP-H11-202323A), JP1997-292522A (JP-H09-292522A), JP1999-133408A (JP-H11-133408A), JP1999-305217A (JP-H11-305217A), JP1998-307291A (JP-H10-307291A), and the like.

[Organic EL Display Device]

Suitable examples of the organic EL display device which is an example of the image display device of the embodiment of the present invention include an aspect which includes, from the visible side, a polarizer, a A/4 plate (a positive A-plate) including the optically anisotropic film of the embodiment of the present invention, and an organic EL display panel in this order.

Furthermore, the organic EL display panel is a display panel constituted with an organic EL element in which an organic light emitting layer (organic electroluminescent layer) is sandwiched between electrodes (between a cathode and an anode). The configuration of the organic EL display panel is not particularly limited but a known configuration is adopted.

### EXAMPLES

Hereinafter, the present invention will be described in more detail with reference to Examples. The materials, the amounts of materials used, the proportions, the treatment details, the treatment procedure, and the like shown in Examples below can be appropriately modified as long as the modifications do not depart from the spirit of the present invention. Therefore, the scope of the present invention should not be construed as being limited to Examples shown below.

[Synthesis of Polymerizable Liquid Crystal Compound (I-1)]

A polymerizable liquid crystal compound (I-1) represented by the following formula was synthesized according to the method described in paragraphs [0161] to [0163] of JP2010-084032A.

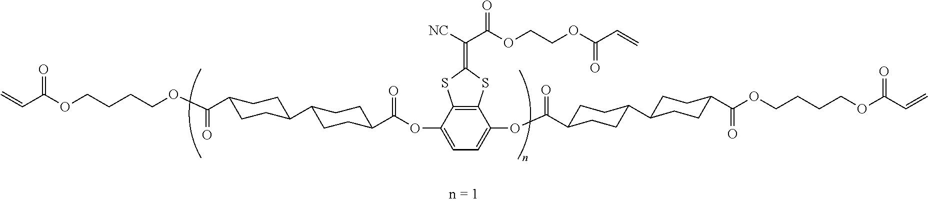

[Synthesis of Polymerizable Liquid Crystal Compound (I-2)]

A polymerizable liquid crystal compound (I-2) represented by the following formula was synthesized by the method described in paragraph [0122] (Example 4) of JP2016-081035A.

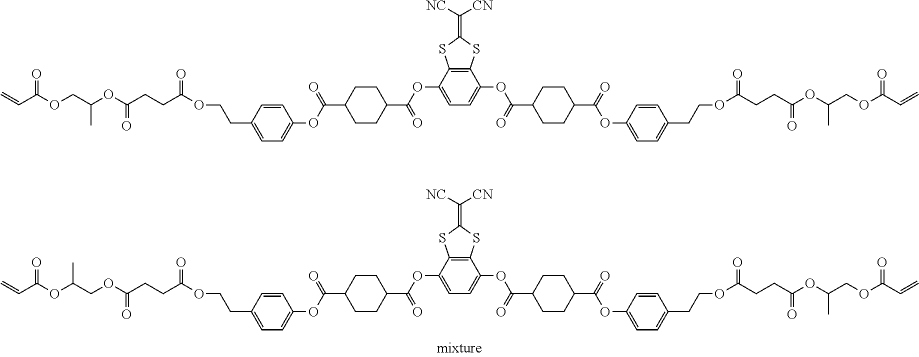

[Synthesis of Polymerizable Liquid Crystal Compound (I-3)]

A polymerizable liquid crystal compound (I-3) represented by the following formula was synthesized according to the method described in paragraph [0252] of JP2011-207765A.

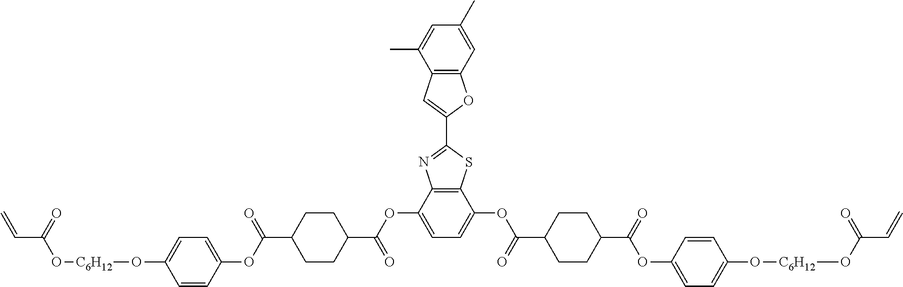

[Synthesis of Polymerizable Liquid Crystal Compound (I-4)]

A polymerizable liquid crystal compound (I-4) represented by the following formula was synthesized according to the method described in paragraphs [0218] to [0233] of Patent Document 2 (WO 2014/010325).

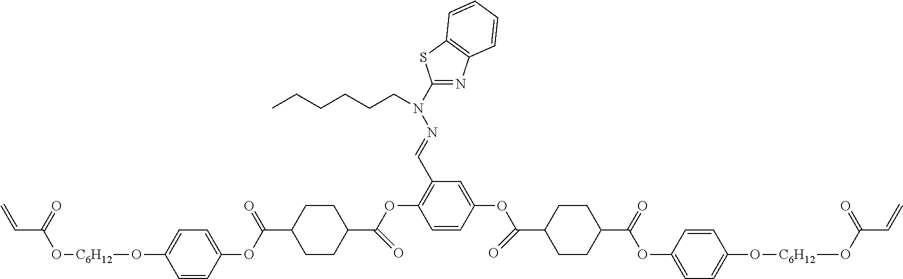

[Synthesis of Polymerizable Liquid Crystal Compound (I-5)]

<Synthesis of Compound (I-1a)>

A compound (I-1a) represented by Formula (I-1a) was synthesized from malonitrile, carbon disulfide, and benzoquinone with reference to the method described in Justus Liebigs Annalen der Chemie, 726, 103-109 (1969).

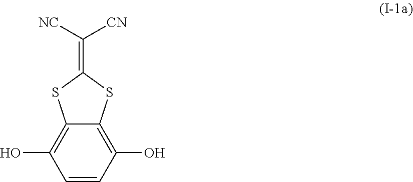 [SMILES: N#CC(C#N)=C1Sc2c(O)ccc(O)c2S1]

<Synthesis of Carboxylic Acid Derivative (S-1-d)>

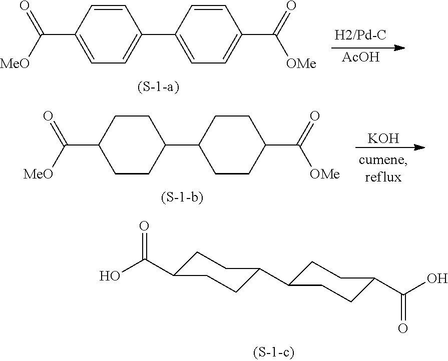 [SMILES: "AcOH" ; COC(=O)c1ccc(-c2ccc(C(=O)OC)cc2)cc1 ; COC(=O)C1CCC(C2CCC(C(=O)OC)CC2)CC1 ; "KOH" ; O=C(O)C1CCC(C2CCC(C(=O)O)CC2)CC1]

As shown in the scheme, 125 g (0.462 mol) of dimethyl 4,4-biphenyl dicarboxylate (S-1-a) was added to 1,000 mL of acetic acid, 12.5 g of a palladium carbon catalyst (wet body) was added thereto, and the mixture was subjected to a catalytic hydrogenation reaction at 130° C. and 2 MPa in an autoclave.

After the completion of the reaction, the mixture was cooled to room temperature and the catalyst was removed by filtration. After evaporating acetic acid under reduced pressure, ethyl acetate and an aqueous sodium hydrogen carbonate solution were added to the residue, the mixture was stirred and subjected to liquid separation to remove the aqueous layer, and the organic layer was washed with 10% physiological saline. The solution was dried by addition of sodium sulfate and the solvent was concentrated to obtain dimethyl 4,4′-dicyclohexane dicarboxylate (S-1-b) (130 g).

While not carrying out further purification, dimethyl 4,4′-dicyclohexane dicarboxylate (130 g), 86.3 g of potassium hydroxide pellets (manufactured by Aldrich, purity: 90%), 1,300 mL of cumene, and 10 mL of polyethylene glycol (PEG2000) were subsequently added thereto, and the mixture was mixed, and heated and stirred at 120° C. with a Dean-Stark tube. After evaporating methanol, the outside equipment was set to a temperature of 180° C., and heating and refluxing were continued for 20 hours while evaporating die solvent. The progress of the reaction was confirmed by nuclear magnetic resonance (NMR), and after the completion of the reaction, the reaction solution was cooled, 1,300 mL of ethanol was added thereto, and the precipitated potassium salt was collected by filtration.

Subsequently, this potassium salt was dissolved in 1,300 mL of water, concentrated hydrochloric acid was added thereto under ice cooling until the pH of the system reached 3, and the precipitated carboxylic acid was collected by filtration to recover a crude product.

The recovered crude product was suspended in 500 mL of acetone, stirred at 50° C. for 30 minutes, and then cooled to room temperature to collect crystals by filtration. By repeating this reslurry operation twice, 93.9 g of crystals of dicyclohexanedicarboxylic acid (S-1-c) having a trans-form content of almost 100% were obtained (yield: 80%).

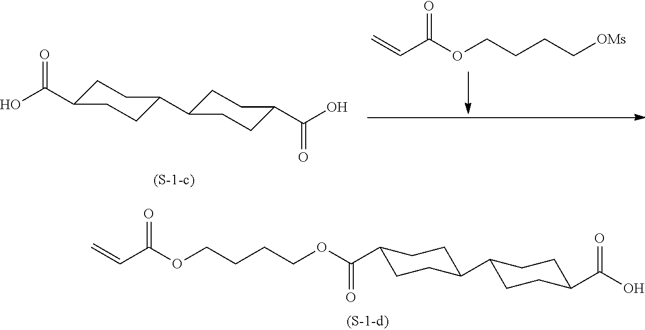 [SMILES: O=C(O)C1CCC(C2CCC(C(=O)O)CC2)CC1 ; C=CC(=O)OCCCCOS(C)(=O)=O ; C=CC(=O)OCCCCOC(=O)C1CCC(C2CCC(C(=O)O)CC2)CC1]

Subsequently, as shown in the scheme, 10.0 g (39.3 mmol) of the compound (S-1-c), 50 mL of N,N-dimethylacetamide (DMAc), 8.0 mL (78.6 mmol) of triethylamine, and 433 mg of 2,6-di-t-butyl-4-methylphenol were mixed at room temperature (23° C.).

To the mixture was added 9.61 g (43.2 mmol) of 4-methylsulfonyloxybutyl acrylate, and the mixture was stirred at 90° C. for 5 hours. The mixture was cooled to room temperature, then a mixed solution of 2.60 g of concentrated hydrochloric acid and 20 mL of water was added thereto, and the mixture was stirred at 40° C. and then subjected to liquid separation. Subsequently, to the organic layer were added 20 mL of toluene and 30 mL of a 5% aqueous sodium hydrogen carbonate solution, and the mixture was stirred at 40° C. and subjected to liquid separation. Next, after washing the organic layer twice with 30 mL of a 1% aqueous sodium hydrogen carbonate solution, 20 mg of 2,2,6,6-tetramethylpiperidin-1-oxyl (TEMPO) was added thereto and then the solvent was evaporated under reduced pressure. Further purification was not performed and a solution of the compound (S-1-d) in toluene was used in the next step as it was. As converted by means of NMR and high performance liquid chromatography (HPLC), the content and the yield of the main product were 28% and 45%, respectively.

<Synthesis of Polymerizable Liquid Crystal Compound (I-5)>

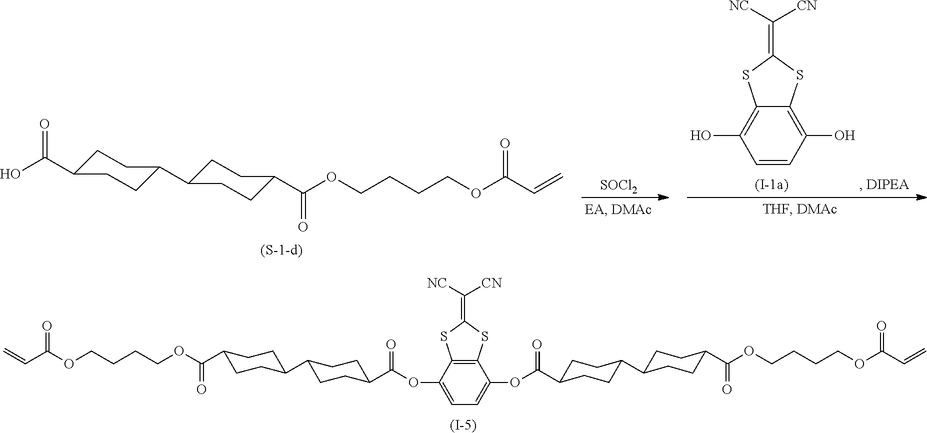

As shown in the scheme, 45 g of a solution of the compound (S-1-d) in toluene [the content of the compound (S-1-d) was 12.89 g (33.9 mmol) as converted from NMR and HPLC], 5.63 g of N,N-dimethylformamide (DMF), and 15 mg of 2,6-di-t-butyl-4-methylphenol were mixed at room temperature, and the internal temperature was lowered to 5° C. To the mixture was added dropwise 4.40 g (37.0 mmol) of thionyl chloride (SOCl₂) while the internal temperature was not elevated to 10° C. or higher. After stirring the mixture at 20° C. for 30 minutes, the separated underlayer was removed. Next, the internal temperature was lowered to 5° C., a solution (75 mL) of 3.83 g (15.4 mmol) of the compound (I-1a) in tetrahydrofuran (THF) was added thereto, 5.38 g (41.6 mmol) of N,N-diisopropylethylamine (DIPEA) was added dropwise thereto while the internal temperature was not elevated to 10° C. or higher, and then the mixture was stirred at room temperature for 2 hours. After stirring the mixture, the mixture was warmed to 45° C. and then neutralized by the addition of 25 mL of water, 2.34 g of triethylamine, and 40 mL of acetone. After subjecting the aqueous layer to liquid separation, 40 mL of acetone was added to the organic layer, followed by cooling to 5° C. to precipitate crystals. After addition of 15 mL of methanol, the precipitated crystals were separated by filtration. The obtained crude product was suspended in 50 mL of acetone and 110 mL of n-hexane at 30° C., stirred at 30° C. for 30 minutes, cooled to 5° C., and collected by filtration. Thereafter, after washing with 4-methoxyphenol-containing methanol, the resultant was taken out and blast-dried. Thus, 13.5 g (13.9 mmol) of a polymerizable liquid crystal compound (I-5) represented by Formula (I-5) was obtained (yield: 90%).

The ¹H-NMR of the obtained polymerizable liquid crystal compound (I-5) is shown below.

¹H-NMR (solvent: CDCl₃) δ (ppm): 1.0-1.2 (m, 12H), 1.3-1.5 (m, 4H), 1.5-1.6 (m, 4H), 1.7-1.8 (m, 8H), 1.8-2.0 (m, 8H), 2.0-2.1 (m, 4H), 2.1-2.2 (m, 4H), 2.2 (tt, 2H), 2.5 (tt, 2H), 4.1 (t, 4H), 4.2 (t, 4H), 5.8 (dd, 2H), 6.1 (dd, 2H), 6.4 (dd, 2H), 7.3 (s, 2H)

[Synthesis of Polymerizable Liquid Crystal Compound (I-6)]

<Synthesis of Compound (II-1a)>

Compound (I-2a) represented by Formula (I-2a) was synthesized by the same method as in compound (I-1a) except that benzoquinone was changed to 2-methylbenzoquinone.

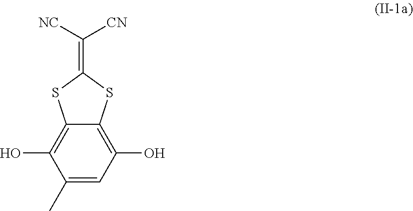 [SMILES: Cc1cc(O)c2c(c1O)SC(=C(C#N)C#N)S2]

<Other Synthesis Methods for Carboxylic Acid Derivative (S-1-d)>

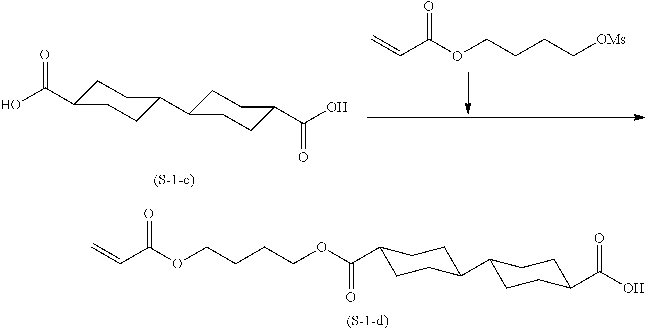 [SMILES: O=C(O)C1CCC(C2CCC(C(=O)O)CC2)CC1 ; C=CC(=O)OCCCCOS(C)(=O)=O ; C=CC(=O)OCCCCOC(=O)C1CCC(C2CCC(C(=O)O)CC2)CC1]

As shown in the scheme, 10.0 g (39.3 mmol) of a compound (S-1-c), 50 mL of N,N-dimethylacetamide (DMAc), 8.0 mL (78.6 mmol) of triethylamine, and 433 mg of 2,6-di-t-butyl-4-methylphenol were mixed at room temperature (23° C.).

To the mixture was added 9.61 g (43.2 mmol) of 4-methylsulfonyloxybutyl acrylate, and the mixture was stirred at 100° C. for 5 hours. After cooling to room temperature, 30 mL of a 1 N aqueous hydrochloric acid solution and 50 mL of toluene were added thereto, and the mixture was stirred at 40° C. and then subjected to liquid separation. The organic layer was sequentially washed with a 5% aqueous sodium hydrogen carbonate solution, a 1% aqueous sodium hydrogen carbonate solution, and a 1% aqueous sodium hydrogen carbonate solution, and then the solvent was evaporated under reduced pressure. The residue was recrystallized with ethanol/toluene/n-hexane to obtain 4.78 g (12.6 mmol) of the carboxylic acid derivative (S-1-d) (yield: 32%).

<Synthesis of Polymerizable Liquid Crystal Compound (I-6)>

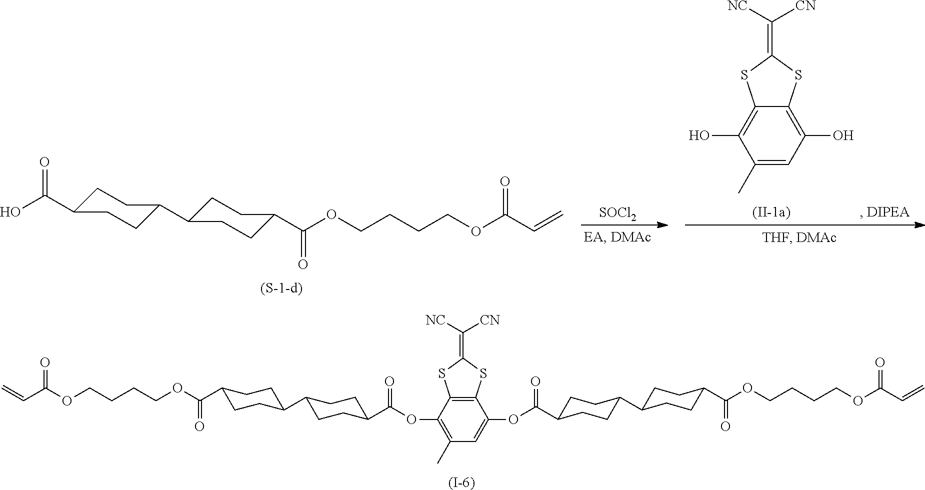

As shown in the scheme, 0.99 g (2.60 mmol) of the compound (S-1-d), 3.5 mL of toluene, 0.5 mL of N,N-dimethylformamide (DMF), and 13 mg of 2,6-di-t-butyl-4-methylphenol were mixed at room temperature, and the internal temperature was lowered to 5° C. To the mixture was added dropwise 0.23 mL (3.12 mmol) of thionyl chloride (SOCl₂) while the internal temperature was not elevated to 10° C. or higher. After stirring the mixture at 20° C. for 30 minutes, the separated underlayer was removed. The internal temperature was lowered to 5° C. and a solution (10.0 mL) of 0.31 g (1.18 mmol) of the compound (II-1a) in THF was added to the residue. 1.13 mL (6.50 mmol) of N,N-diisopropylethylamine (DIPEA) was added dropwise thereto while the internal temperature was not elevated to 10° C. or higher, and then the mixture was stirred at room temperature for 2 hours. After stirring the mixture, 15 mL of a 1 N aqueous hydrochloric acid solution and 15 mL of ethyl acetate were added thereto to stop the reaction, and the mixture was subjected to liquid separation. The organic layer was washed with 10% physiological saline and then dried over magnesium sulfate, and the solvent was evaporated under reduced pressure. By recrystallization from tetrahydrofuran (THF) and isopropanol, 1.06 g (1.08 mmol) of a polymerizable liquid crystal compound (I-6) was obtained (yield: 91%). 0.5% by mass of 4′-(4-acryloylbutoxycarbonyl)-[1,1′-bi(cyclohexane)]-4-carboxylic anhydride was included in the obtained compound.

The ¹H-NMR of the obtained polymerizable liquid crystal compound (I-6) is shown below.

¹H-NMR (solvent: CDCl₃) δ (ppm): 1.0-1.2 (m, 12H), 1.3-1.5 (m, 4H), 1.5-1.6 (m, 4H), 1.7-1.8 (m, 8H), 1.8-2.0 (m, 8H), 2.0-2.1 (m, 4H), 2.1-2.2 (m, 4H), 2.2 (s, 3H), 2.2 (tt, 2H), 2.5 (tt, 1H), 2.6 (tt, 1H), 4.1 (t, 4H), 4.2 (t, 4H), 5.8 (dd, 2H), 6.1 (dd, 2H), 6.4 (dd, 2H), 7.2 (s, 1H)

[Synthesis of Polymerizable Liquid Crystal Compound (I-7)]

<Synthesis of Compound (III-1a)>

Malononitrile (13.2 g, 200 mmol) was dissolved in N,N-dimethylformamide (60 mL) and ethanol (90 mL). 15.23 g (200 mmol) of carbon disulfide and 10 mL of water were added dropwise to the solution at an internal temperature of 5° C. or lower while stirring under ice cooling, and then a solution obtained by dissolving 26.1 g (400 mmol) of potassium hydroxide having a 86% content in 45 mL of water in advance was slowly added dropwise thereto. After the dropwise addition, stirring was carried out at an internal temperature of 5° C. or lower for 30 minutes.

Subsequently, 6.0 mL (105 mmol) of acetic acid was added to the reaction solution under a nitrogen stream to adjust the pH of the solution to 6, and then a mixed solution of 68.3 g (purity: 99%, 410 mmol) of 2-t-butyl-1,4-benzoquinone, 22.9 mL (400 mmol) of acetic acid, and 200 mL of acetone was slowly added dropwise thereto while maintaining the internal temperature at 2° C. or lower. The mixture was stirred at the same temperature for 30 minutes and then warmed to 45° C., a mixed solution of acetonitrile 100 mL and water 100 mL was added thereto, followed by dropwise addition of 100 mL of water, and the mixture was stirred at the same temperature for 30 minutes to precipitate crystals.

Thereafter, the mixture was cooled to 20° C., and the precipitated crystals were collected by filtration and washed with 200 mL of acetonitrile/200 mL of water. The obtained crude product, 500 mL of toluene, and 120 mL of acetonitrile were mixed, and the mixture was warmed to 45° C., and the suspension was stirred at 45° C. for 30 minutes.

Thereafter, the suspension was cooled to an internal temperature of 5° C., and the crystals were collected by filtration and washed with 160 mL of toluene. The crystals were dried under reduced pressure at 50° C. to obtain 43.9 g (yield: 72%) of a compound (III-1-a) represented by Formula (III-1a) as a pale yellow solid.

The ¹H-NMR of the obtained compound (III-1-a) is shown below.

¹H-NMR (DMSO-d₆) δ (ppm): 1.35 (s, 9H), 6.89 (s, 1H)

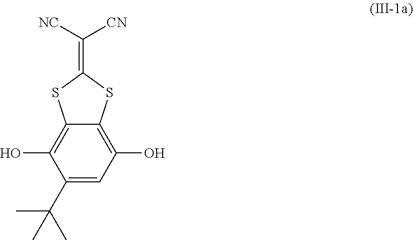 [SMILES: CC(C)(C)c1cc(O)c2c(c1O)SC(=C(C#N)C#N)S2]

<Synthesis of Polymerizable Liquid Crystal Compound (I-7)>

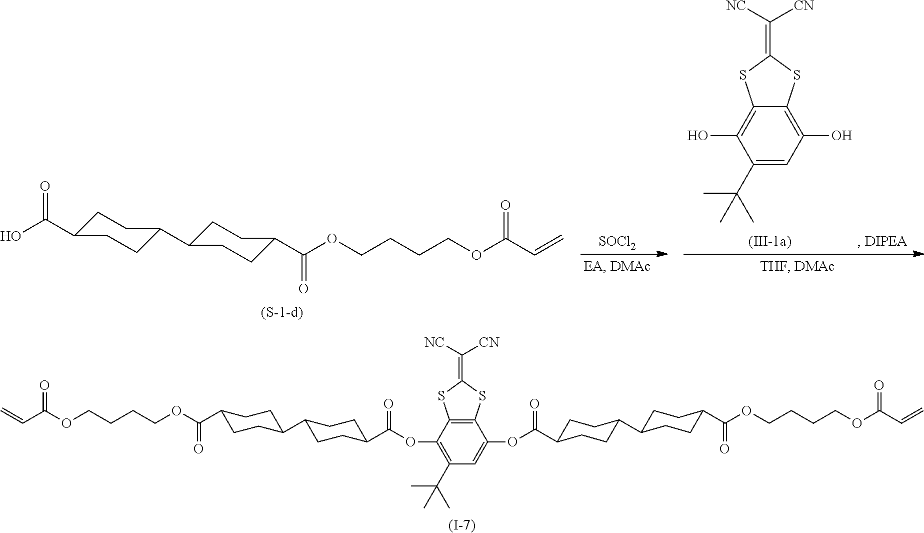

As shown in the scheme, 45 g of a solution of the compound (S-1-d) in toluene [the content of the compound (S-1-d) was 12.89 g (33.9 mmol) as converted from NMR and HPLC], 5.60 g of N,N-dimethylformamide (DMF), and 15 mg of 2,6-di-t-butyl-4-methylphenol were mixed at room temperature, and the internal temperature was lowered to 5° C. To the mixture was added dropwise 4.47 g (37.6 mmol) of thionyl chloride (SOCl₂) while the internal temperature was not elevated to 10° C. or higher. After stirring the mixture at 20° C. for 30 minutes, the separated underlayer was removed. Next, the internal temperature was lowered to 5° C., a mixed solution of 4.69 g (15.4 mmol) of the compound (111-1a), an ethyl acetate solution (20 mL), and N,N-dimethylformamide (12 mL) was added thereto, 5.57 g (43.2 mmol) of N,N-diisopropylethylamine (DIPEA) was added dropwise thereto while the internal temperature was not elevated to 10° C. or higher, and then the mixture was stirred at 30° C. for 2 hours. After stirring the mixture, the reaction was stopped by adding 15 mL of methanol, and then the mixture was warmed to 45° C. Thereafter, an aqueous sodium acetate solution (3.15 g of sodium acetate/25 mL of water) was added dropwise thereto to perform neutralization. After separating the aqueous layer, the organic layer was washed with 25 mL of water, and the aqueous layer was separated. 15 mL of ethyl acetate and 100 mL of methanol were added to the organic layer, and then the organic layer was cooled to 5° C. to precipitate crystals, which were collected by filtration. Thereafter, the crystals were washed with 4-methoxyphenol-containing methanol, taken out, and blast-dried. Thus, 13.5 g (13.1 mmol) of a polymerizable liquid crystal compound (I-7) represented by Formula (I-7) was obtained (yield: 85%).

The ¹H-NMR of the obtained polymerizable liquid crystal compound (I-7) is shown below.

¹H-NMR (solvent: CDCl₃) δ (ppm): 1.0-1.2 (m, 12H), 1.3 (s, 9H), 1.3-1.5 (m, 4H), 1.5-1.6 (m, 4H), 1.7-1.8 (m, 8H), 1.8-2.0 (m, 8H), 2.0-2.1 (m, 4H), 2.1-2.3 (m, 6H), 2.5 (tt, 1H), 2.6 (tt, 1H), 4.1 (m. 4H), 4.2 (m, 4H), 5.8 (dd, 2H), 6.1 (dd, 2H), 6.4 (dd, 2H), 7.3 (s, 1H)

[Synthesis of Polymerizable Compound (II-1)]

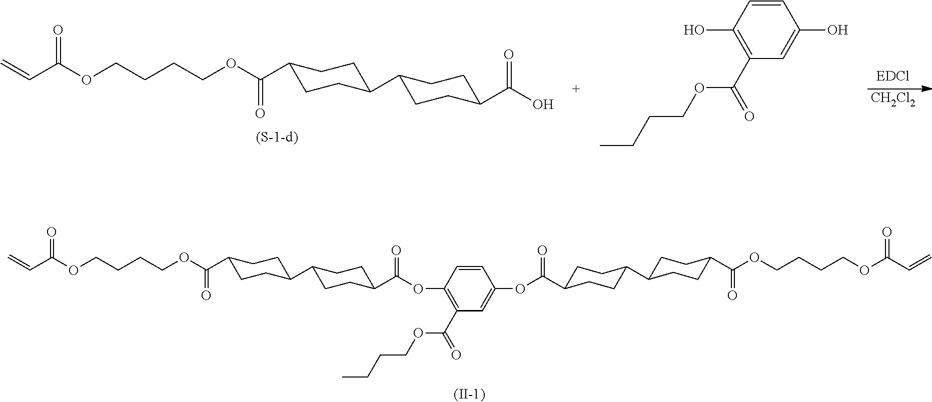 [SMILES: C=CC(=O)OCCCCOC(=O)C1CCC(C2CCC(C(=O)O)CC2)CC1 ; CCCCOC(=O)c1cc(O)ccc1O ; "CH2Cl2" ; C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(C(=O)OCCCC)c3)CC2)CC1 ; "(II-1)"]

As shown in the scheme, 1.9 g (5.0 mmol) of the carboxylic acid derivative (S-1-d), 0.48 g (2.27 mmol) of butyl 2,5-dihydroxybenzoate, 20 mL of methylene chloride, and 40 mg of 2,6-di-t-butyl-4-methylphenol were mixed at room temperature. To the mixture were added 1.05 g of 3-[(ethylcarboximidoyl)amino]-N,N-dimethyl-1-propanamine hydrochloride and 0.55 g of triethylamine, and the mixture was stirred at room temperature for 5 hours.

After the completion of the reaction, water was added to remove the aqueous layer, and the residue was washed with diluted hydrochloric acid. The organic layer was dried over magnesium sulfate, the desiccant was filtered, and then, the solvent was evaporated under reduced pressure.

The crystals precipitated by the addition of methanol were collected by filtration, and further reslurry-washed with methanol and filtered to obtain 1.38 g of the polymerizable compound (II-1) represented by Formula (II-1) (yield: 65%).

[Synthesis of Polymerizable Compound (II-2)]

A polymerizable compound (II-2) represented by Formula (II-2) was synthesized by the same manner as for the polymerizable compound (II-1), except that butyl 2,5-dihydroxybenzoate in the synthesis of the polymerizable compound (II-1) was replaced with 2-methylhydroquinone.

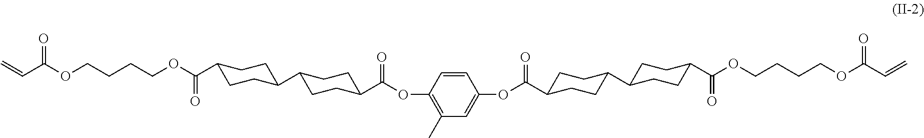 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(C)c3)CC2)CC1]

[Synthesis of Polymerizable Compound (II-3)]

<Synthesis of Phenol Derivative 1>

Parahydroxybenzoic acid (9.0 g) was stirred in dimethylacetamide (70 mL), and triethylamine (9.8 mL), 4-acryloyloxybutyl methanesulfonate (11.1 g), and dibutylhydroxytoluene (BHT) (0.2 g) were added thereto, and the mixture was stirred at an internal temperature of 70° C. for 10 hours. After cooling to 30° C., water and ethyl acetate were added thereto to remove the aqueous layer, and the mixture was washed with saturated aqueous sodium hydrogen carbonate, diluted hydrochloric acid, and physiological saline in this order. The organic layer was dried over magnesium sulfate, the desiccant was filtered, BHT (0.1 g) was added thereto, and the solvent was evaporated under reduced pressure to obtain a phenol derivative 1 represented by the following formula.

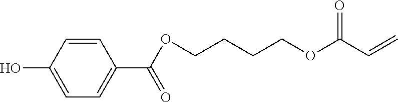 [SMILES: C=CC(=O)OCCCCOC(=O)c1ccc(O)cc1]

<Synthesis of Polymerizable Compound (II-3)>

1.9 g (5.0 mmol) of the carboxylic acid derivative (S-1-d), a phenol derivative 1 (1.20 g (4.55 mmol)), 20 mL of methylene chloride, and 40 mg of 2,6-di-t-butyl-4-methylphenol were mixed at room temperature. To the mixture were 1.05 g of 3-[(ethylcarboximidoyl)amino]-N,N-dimethyl-1-propanamine hydrochloride and 0.55 g of triethylamine, and the mixture was stirred at room temperature for 5 hours.

After the completion of the reaction, water was added to remove the aqueous layer, and the residue was washed with diluted hydrochloric acid. The organic layer was dried over magnesium sulfate, the desiccant was filtered, and then the solvent was evaporated under reduced pressure. The crystals precipitated by addition of methanol were collected by filtration and purified by silica gel column chromatography to obtain 2.89 g of a polymerizable compound (II-3) represented by Formula (II-3). (yield: 68%).

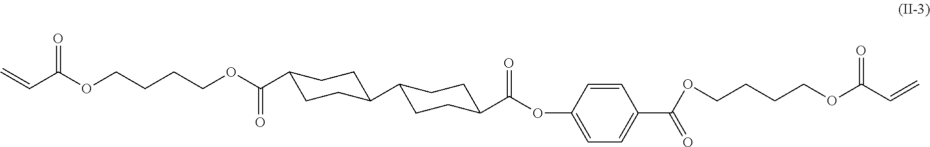 [SMILES: C=CC(=O)OCCCCOC(=O)c1ccc(OC(=O)C2CCC(C3CCC(C(=O)OCCCCOC(=O)C=C)CC3)CC2)cc1]

[Synthesis of Polymerizable Compound (II-4)]

<Synthesis of Phenol Derivative 2>

Vanillic acid (10.9 g) was stirred in dimethylacetamide (70 mL), and triethylamine (9.8 mL), 4-acryloyloxybutyl methanesulfonate (11.1 g), and BHT (0.2 g) were added thereto, followed by stirring at 70° C. for 10 hours. After cooling to 30° C., water and ethyl acetate were added thereto to remove the aqueous layer, and the mixture was washed with saturated aqueous sodium hydrogen carbonate, diluted hydrochloric acid, and physiological saline in this order.

The organic layer was dried over magnesium sulfate, the desiccant was filtered, BHT (0.1 g) was added thereto, and the solvent was evaporated under reduced pressure to obtain a phenol derivative 2 represented by the following formula.

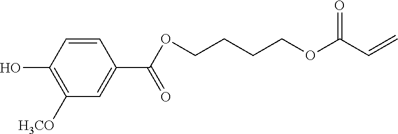 [SMILES: C=CC(=O)OCCCCOC(=O)c1ccc(O)c(OC)c1]

<Synthesis of Polymerizable Compound (II-4)>

1.90 g (5.0 mmol) of the carboxylic acid derivative (S-1-d), 15 mL of ethyl acetate (EA), 4.5 mL of N,N-dimethylacetamide (DMAc), and 40 mg of 2,6-di-t-butyl-4-methylphenol were mixed at room temperature, and the internal temperature was lowered to 5° C. To the mixture was added dropwise 0.44 mL (6.0 mmol) of thionyl chloride (SOCl₂) while the internal temperature was not elevated to 10° C. or higher. After stirring the mixture at 5° C. for 1 hour, a solution (5 mL) of a phenol derivative 2 (1.47 g (5.0 mmol)) in tetrahydrofuran (THF) was added thereto. 2.09 mL (12.0 mmol) of N,N-diisopropylethylamine (DIPEA) was added dropwise thereto and then the mixture was stirred at room temperature for 6 hours. After stirring the mixture, 15 mL of a 1 N aqueous hydrochloric acid solution and 15 mL of ethyl acetate were added thereto to stop the reaction, and die mixture was subjected to liquid separation. The organic layer was washed with 10% physiological saline and then dried over magnesium sulfate, and the solvent was evaporated under reduced pressure. The obtained crude product was purified by silica gel column chromatography to obtain 1.84 g of a polymerizable compound (II-4) represented by Formula (II-4) (yield: 56%).

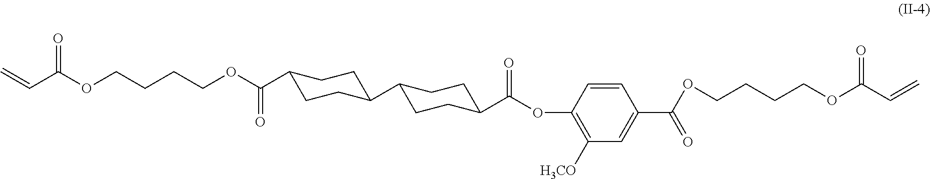 [SMILES: C=CC(=O)OCCCCOC(=O)c1ccc(OC(=O)C2CCC(C3CCC(C(=O)OCCCCOC(=O)C=C)CC3)CC2)c(OC)c1]

[Synthesis of Polymerizable Compound (II-5)]

<Synthesis of Carboxylic Acid Derivative A>

Trans-1,4-cyclohexadicarboxylic acid (10 g), mesyl chloride (1.9 mL), and BHT (0.2 g) were stirred in THF (72 mL), and triethylamine (3.7 mL) was added dropwise thereto while the internal temperature was maintained at 25° C. or lower. After stirring the mixture at room temperature for 2 hours, N,N-dimethylaminopyridine (0.3 g) and 4-hydroxybutyl acrylate (3.1 g) were added thereto, and triethylamine (3.7 mL) was added dropwise to the mixture at an internal temperature of 25° C. or lower. After stirring the mixture at room temperature for 3 hours, diluted hydrochloric acid and ethyl acetate were added thereto to remove the aqueous layer, and the mixture was washed with diluted hydrochloric acid, saturated aqueous sodium hydrogen carbonate, and physiological saline in this order. The organic layer was dried over magnesium sulfate, the desiccant was filtered, and the solvent was evaporated under reduced pressure to obtain a carboxylic acid derivative A (7.1 g) represented by the following formula.

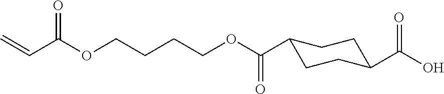 [SMILES: C=CC(=O)OCCCCOC(=O)C1CCC(C(=O)O)CC1]

<Synthesis of Polymerizable Compound (II-5)>

1.90 g (5.0 mmol) of the carboxylic acid derivative (S-1-d), 1.49 g (5.0 mmol) of the carboxylic acid derivative A, 15 mL of ethyl acetate (EA), 4.5 mL of N,N-dimethylacetamide (DMAc), and 40 mg of 2,6-di-t-butyl-4-methylphenol were mixed at room temperature, and the internal temperature was lowered to 5° C. To the mixture was added dropwise 0.79 mL (10.9 mmol) of thionyl chloride (SOCl₂) while the internal temperature was not elevated to 10° C. or higher. After stirring the mixture at 5° C. for 1 hour, a solution (5 mL) of 2-methylhydroquinone (0.56 g, 4.55 mmol) in tetrahydrofuran (THF) was added thereto. 3.56 mL (20.5 mmol) of N,N-diisopropylethylamine (DIPEA) was added dropwise thereto and the mixture was stirred at room temperature for 6 hours. After stirring the mixture, 15 mL of a 1 N aqueous hydrochloric acid solution and 15 mL of ethyl acetate were added thereto to stop the reaction, and the mixture was subjected to liquid separation. The organic layer was washed with 10% physiological saline and then dried over magnesium sulfate, and the solvent was evaporated under reduced pressure. The obtained crude product was purified by silica gel column chromatography to obtain 1.05 g of a polymerizable compound (II-S) represented by Formula (II-5) (yield: 30%).

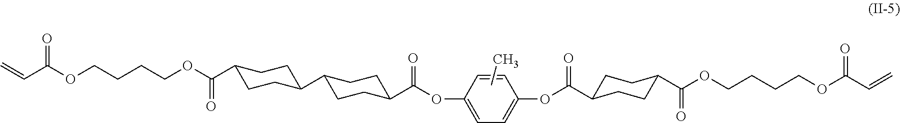

[Synthesis of Mixture (II-6) of Polymerizable Compounds]

1.90 g (5.0 mmol) of the carboxylic acid derivative (S-1-d), 1.49 g (5.0 mmol) of the carboxylic acid derivative A, 15 mL of ethyl acetate (EA), 4.5 mL of N,N-dimethylacetamide (DMAc), and 40 mg of 2,6-di-t-butyl-4-methylphenol were mixed at room temperature, and the internal temperature was lowered to 5° C. To the mixture was added dropwise 0.79 mL (10.9 mmol) of thionyl chloride (SOCl₂) while the internal temperature was not elevated to 10° C. or higher. After stirring the mixture at 5° C. for 1 hour, a solution (5 mL) of 2-methylhydroquinone (0.56 g, 4.55 mmol) in tetrahydrofuran (THF) was added thereto. 3.56 mL (20.5 mmol) of N,N-diisopropylethylamine (DIPEA) was added dropwise thereto and the mixture was stirred at room temperature for 6 hours. After stirring the mixture, 15 mL of a 1 N aqueous hydrochloric acid solution and 15 mL of ethyl acetate were added thereto to stop the reaction, and the mixture was subjected to liquid separation. The organic layer was washed with 10% physiological saline and then dried over magnesium sulfate, and the solvent was evaporated under reduced pressure. The crystals precipitated by the addition of methanol were collected by filtration, and further reslurry-washed with methanol and filtered to obtain 2.37 g of a polymerizable compound mixture (II-6) represented by the following formula. According to high performance liquid chromatography (HPLC) analysis, a mixing ratio of the polymerizable compounds was found to be Compound having 5 rings/Compound having 4 rings/Compound having 3 rings=23/51/26.

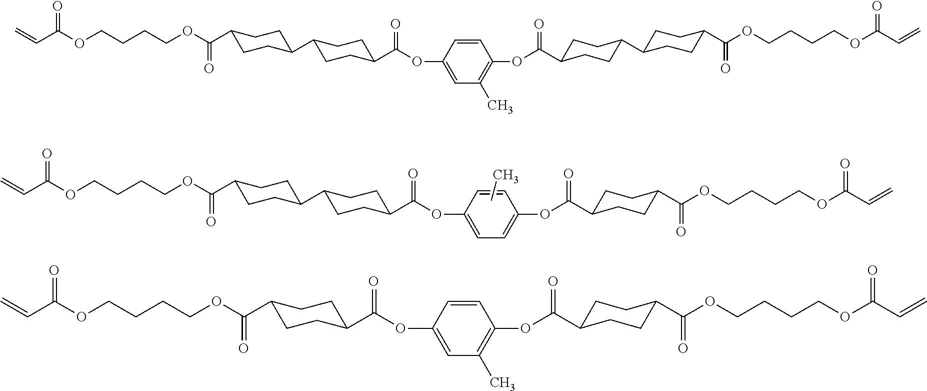

[Synthesis of Polymerizable Compound (II-7)]

0.2 g (1.31 mmol) of 2,3,5-trimethyl-1,4-benzenediol, 1.05 g (2.76 mmol) of the carboxylic acid derivative A, 37 mg (0.30 mmol) of 4-dimethylaminopyridine, and 1 mg of 2,6-di-t-butyl-4-methylphenol were dissolved in 7 mL of dichloromethane, and then 1.16 g (6.07 mmol) of l-(3-dimethylaminopropyl)-3-ethylcarbodiimide hydrochloride was added thereto.

The mixture was stirred at room temperature (23° C.) for 10 hours, and the reaction solution was directly purified by silica gel column chromatography to obtain 0.71 g (yield: 68%) of a polymerizable compound (II-7) represented by the following formula.

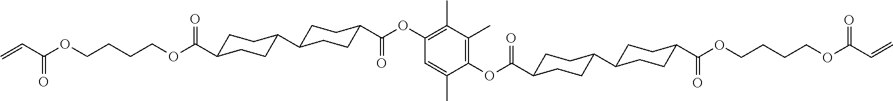 [SMILES: C=CC(=O)OCCCCOC(=O)C1CCC(C2CCC(C(=O)Oc3cc(C)c(OC(=O)C4CCC(C5CCC(C(=O)OCCCCOC(=O)C=C)CC5)CC4)c(C)c3C)CC2)CC1]

The ¹H-NMR of the obtained polymerizable compound (II-7) is shown below.

¹H-NMR (solvent: CDCl₃) δ (ppm): 6.70 (s, 1H), 6.41 (d, 2H), 6.11 (dd, 2H), 5.84 (d, 2H), 4.19 (t, 4H), 4.10 (t, 4H), 2.59-2.40 (m, 2H), 2.28-0.97 (m, 46H)

[Synthesis of Polymerizable Compound (II-8)]

1.94 g (13.8 mmol) of 2-methoxy-1,4-benzenediol, 13.2 g (34.7 mmol) of the carboxylic acid derivative A, 170 mg (1.39 mmol) of 4-dimethylaminopyridine, and 150 mg (0.68 mmol) of 2,6-di-t-butyl-4-methylphenol were dissolved in 25 mL of dichloromethane, and then 7.20 g (37.6 mmol) of l-(3-dimethylaminopropyl)-3-ethylcarbodiimide hydrochloride was added thereto.

The mixture was stirred at room temperature (23° C.) for 2 hours, and the reaction solution was directly purified by silica gel column chromatography to obtain 9.13 g (yield: 76%) of a polymerizable compound (II-8) represented by the following formula.

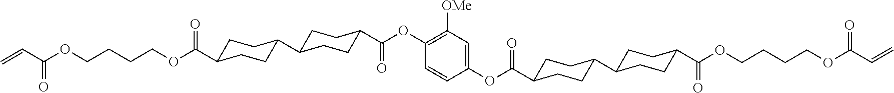 [SMILES: C=CC(=O)OCCCCOC(=O)C1CCC(C2CCC(C(=O)Oc3ccc(OC(=O)C4CCC(C5CCC(C(=O)OCCCCOC(=O)C=C)CC5)CC4)c(OC)c3)CC2)CC1]

The ¹H-NMR of the obtained polymerizable compound (II-8) is shown below.

¹H-NMR (solvent: CDCl₃) δ (ppm): 6.97 (d, 1H), 6.68-6.63 (m, 2H), 6.41 (d, 2H), 6.13 (dd, 2H), 5.84 (d, 2H), 4.19 (t, 4H), 4.10 (t, 4H), 3.78 (s, 3H), 2.41-2.44 (m, 2H)), 2.55-2.15 (m, 6H), 2.02-1.99 (m, 4H), 1.86-1.74 (m, 16H), 1.61-1.36 (m, 8H), 1.12-1.01 (m, 12H)

[Synthesis of Polymerizable Compound (II-9)]

Using the carboxylic acid derivative (S-1-d), the following carboxylic acid derivative A-9, and methylhydroquinone as raw materials, the following polymerizable compound (II-9) was synthesized by the same synthesis method as for the above-mentioned polymerizable compound (II-7).

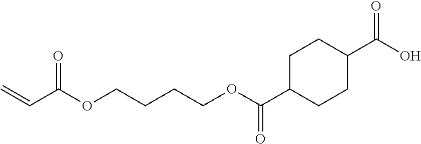 [SMILES: C=CC(=O)OCCCCOC(=O)C1CCC(C(=O)O)CC1]

Polymerizable Compound (II-9)

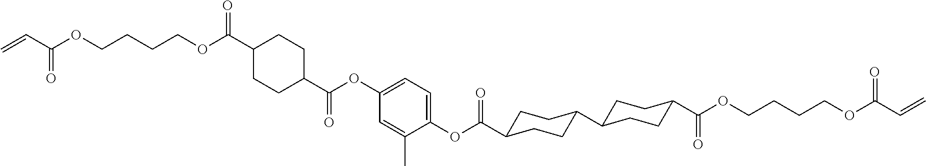 [SMILES: C=CC(=O)OCCCCOC(=O)C1CCC(C(=O)Oc2ccc(OC(=O)C3CCC(C4CCC(C(=O)OCCCCOC(=O)C=C)CC4)CC3)c(C)c2)CC1]

[Synthesis of Polymerizable Compound (II-10)]

Using the following carboxylic acid derivative A-10 and 2-methoxy-1,4-benzenediol as raw materials, the following polymerizable compound (II-10) was synthesized by the same synthesis method as for the above-mentioned polymerizable compound (II-8).

Carboxylic Acid Derivative A-10

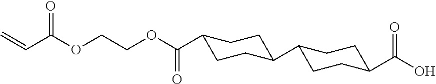 [SMILES: C=CC(=O)OCCOC(=O)C1CCC(C2CCC(C(=O)O)CC2)CC1]

Polymerizable Compound (II-10)

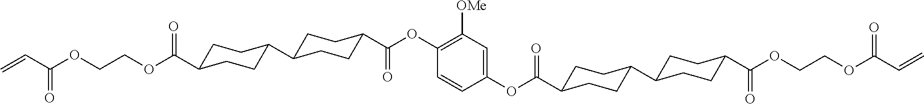 [SMILES: C=CC(=O)OCCOC(=O)C1CCC(C2CCC(C(=O)Oc3ccc(OC(=O)C4CCC(C5CCC(C(=O)OCCOC(=O)C=C)CC5)CC4)c(OC)c3)CC2)CC1]

[Synthesis of Polymerizable Compound (II-11)]

Using the following carboxylic acid derivative A-11 and 2-methoxy-1,4-benzenediol as raw materials, the following polymerizable compound (II-11) was synthesized by the same synthesis method as for the above-mentioned polymerizable compound (II-8).

Carboxylic Acid Derivative A-11

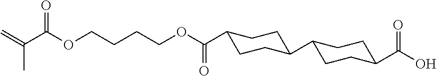 [SMILES: C=C(C)C(=O)OCCCCOC(=O)C1CCC(C2CCC(C(=O)O)CC2)CC1]

Polymerizable Compound (II-11)

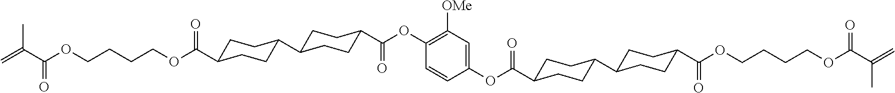 [SMILES: C=C(C)C(=O)OCCCCOC(=O)C1CCC(C2CCC(C(=O)Oc3ccc(OC(=O)C4CCC(C5CCC(C(=O)OCCCCOC(=O)C(=C)C)CC5)CC4)c(OC)c3)CC2)CC1]

[Synthesis of Polymerizable Compound (II-12)]

Using the following carboxylic acid derivative A-12 and 2-methoxy-1,4-benzenediol as raw materials, the following polymerizable compound (II-12) was synthesized by the same synthesis method as for the above-mentioned polymerizable compound (II-8).

Carboxylic Acid Derivative A-12

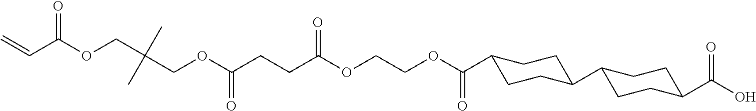 [SMILES: C=CC(=O)OCC(C)(C)COC(=O)CCC(=O)OCCOC(=O)C1CCC(C2CCC(C(=O)O)CC2)CC1]

Polymerizable Compound (II-12)

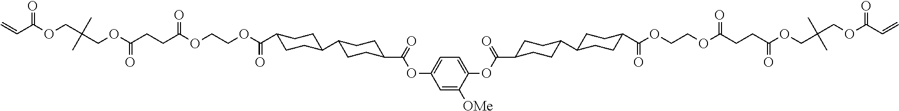 [SMILES: C=CC(=O)OCC(C)(C)COC(=O)CCC(=O)OCCOC(=O)C1CCC(C2CCC(C(=O)Oc3ccc(OC(=O)C4CCC(C5CCC(C(=O)OCCOC(=O)CCC(=O)OCC(C)(C)COC(=O)C=C)CC5)CC4)c(OC)c3)CC2)CC1]

[Synthesis of Polymerizable Compound (II-13)]

Using the following carboxylic acid derivative A-13 and 2-methoxy-1,4-benzenediol as raw materials, the following polymerizable compound (II-13) was synthesized by the same synthesis method as for the above-mentioned polymerizable compound (II-8).

Carboxylic Acid Derivative A-13

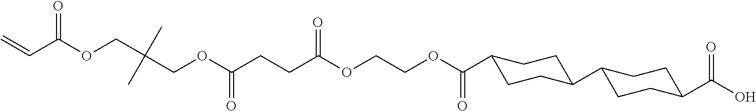 [SMILES: C=CC(=O)OCC(C)(C)COC(=O)CCC(=O)OCCOC(=O)C1CCC(C2CCC(C(=O)O)CC2)CC1]

Polymerizable Compound (II-13)

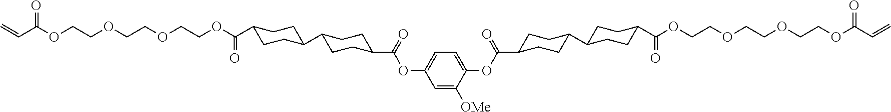 [SMILES: C=CC(=O)OCCOCCOCCOC(=O)C1CCC(C2CCC(C(=O)Oc3ccc(OC(=O)C4CCC(C5CCC(C(=O)OCCOCCOCCOC(=O)C=C)CC5)CC4)c(OC)c3)CC2)CC1]

[Comparative Compound 1]

A liquid crystal compound 3 represented by the following formula described in Comparative Example 3 of WO2014/132978A was synthesized as a comparative compound 1.

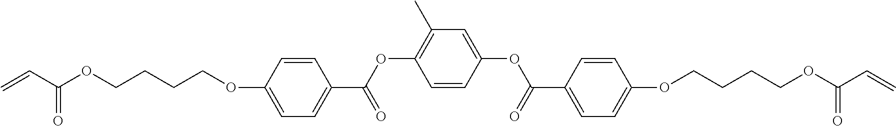 [SMILES: C=CC(=O)OCCCCOc1ccc(C(=O)Oc2ccc(OC(=O)c3ccc(OCCCCOC(=O)C=C)cc3)c(C)c2)cc1]

### Examples 1 to 12 and Comparative Examples 1 to 4

[Preparation of Composition for Photo-Alignment Film)

The composition for forming a cured film described in Example 1 of WO2016/002722A was prepared as a composition for a photo-alignment film.

[Manufacture of Cellulose Acylate Film 1]

### (Manufacture of Core Layer Cellulose Acylate Dope)

The following composition was put into a mixing tank and stirred to dissolve the respective components to prepare a cellulose acetate solution for use as a core layer cellulose acylate dope.

Core layer cellulose acylate dope

| | |
|---|---|
| Cellulose acetate having a degree of acetyl substitution | 100 parts by mass |
| of 2.88 | |
| Polyester compound B described in Examples of | 12 parts by mass |
| JP2015-227955A | |
| The following compound G | 2 parts by mass |
| Methylene chloride (first solvent) | 430 parts by mass |
| Methanol (second solvent) | 64 parts by mass |

Compound G

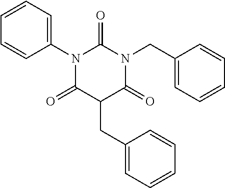 [SMILES: O=C1C(Cc2ccccc2)C(=O)N(c2ccccc2)C(=O)N1Cc1ccccc1]

(Manufacture of Outer Layer Cellulose Acylate Dope)

10 parts by mass of the following matting agent solution was added to 90 parts by mass of the core layer cellulose acylate dope to prepare a cellulose acetate solution for use as an outer layer cellulose acylate dope.

Matting agent solution

| | |
|---|---|
| Silica particles with an average | 2 parts by mass |
| particle size of 20 nm | |
| (AEROSIL R972, manufactured by | |
| Nippon Aerosil Co., Ltd.) | |
| Methylene chloride (first solvent) | 76 parts by mass |
| Methanol (second solvent) | 11 parts by mass |
| The core layer cellulose acylate dope | 1 part by mass |

(Manufacture of Cellulose Acylate Film 1)

The core layer cellulose acylate dope and the outer layer cellulose acylate dope were filtered through a filter paper having an average pore diameter of 34 μm and a sintered metal filter having an average pore diameter of 10 μm, and then all the three layers of the core layer cellulose acylate dope and the outer layer cellulose acylate dopes on both sides thereof were simultaneously cast on a drum at 20° C. from a casting port (band caster). Peeling was performed in a state where the solvent content was approximately 20% by mass, and the both ends of the film in the width direction were fixed with a tenter clip and dried while stretching the film at a stretch ratio of 1.1 times in the transverse direction. Thereafter, by transporting the film between rolls of a heat treatment device, the film was further dried to manufacture a cellulose acylate film 1 having a thickness of 40 μm. The thickness of the core layer was 36 μm and the thickness of each of the outer layers arranged on the both sides of the core layer was 2 μm. In addition, the in-plane retardation of the obtained cellulose acylate film 1 was 0 nm.

[Manufacture of Optical Film]

The composition for a photo-alignment film prepared above was applied onto one surface of die manufactured cellulose acylate film 1 with a bar coater. After the application, the film was dried for 1 minute on a hot plate at 120° C. to remove the solvent, thereby forming a photoisomerization composition layer having a thickness of 0.3 μm. The obtained photoisomerization composition layer was irradiated with polarized ultraviolet rays (10 mJ/cm², an ultra-high pressure mercury lamp used) to form a photo-alignment film.

Subsequently, a polymerizable composition (coating liquid for an optically anisotropic film) having the following formulation was prepared and applied onto the photo-alignment film with a bar coater. The coating film was subjected to an alignment treatment at 135° C. to form a liquid crystal layer. Thereafter, the liquid crystal layer was cooled to 120° C. and subjected to alignment fixation by irradiation with ultraviolet rays at 1,000 mJ/cm² to form an optically anisotropic film, thereby obtaining an optical film for measuring a wavelength dispersion. The in-plane retardation of the obtained optical film was 140 nm.

Coating liquid for optically anisotropic film

| | |
|---|---|
| Polymerizable liquid crystal compound (I) (compound described in Table 7 below) | 12.00 parts by mass |
| Polymerizable compound (II) (compound described in Table 7 below) | 3.00 parts by mass |
| The following polymerization initiator S-1 (oxime type) | 0.075 parts by mass |
| The following fluorine-containing compound A | 0.023 parts by mass |
| Hisolve MTEM (manufactured by TOHO Chemical Industry Co., Ltd.) | 0.3 parts by mass |
| NK Ester A-200 (manufactured by Shin Nakamura Chemical Co., Ltd.) | 0.15 parts by mass |
| Cyclopentanone | 36.3 parts by mass |

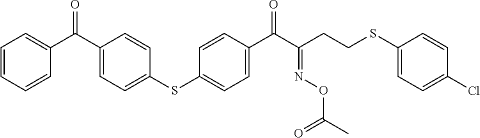 [SMILES: CC(=O)O/N=C(\CCSc1ccc(Cl)cc1)C(=O)c1ccc(Sc2ccc(C(=O)c3ccccc3)cc2)cc1]

Polymerization initiator S-1 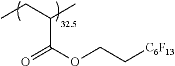 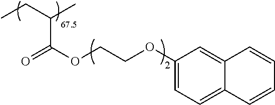
Fluorine-containing compound A

<Retardation>

With regard to the manufactured optical film, a retardation value at a wavelength of 450 nm (Re(450)) and a retardation value at a wavelength of 550 nm (Re(550)) were measured using AxoScan (OPMF-1, manufactured by Opto Science, Inc.), and Re(450)/Re(550) was calculated. The obtained calculation results were classified according to the following standard. The results are shown in Table 7 below.

A1: Re(450)/Re(550) is less than 0.70.

A2: Re(450)/Re(550) is 0.70 or more and less than 0.80.

A3: Re(450)/Re(550) is 0.80 or more and less than 0.95.

D: Re(450)/Re(550) is 0.95 or more.

<Surface Condition>

With regard to the manufactured optical film, the surface condition was confirmed with a polarizing microscope and visual observation, and evaluated according to the following standard.

A: Almost no bright spots or streak-like defects are observed.

B: Some bright spots or streak-like defects are observed, but there is no practical problem.

C: There are many bright spots or streak-like defects.

D: Not aligned.

TABLE 7

| | Polymerizable | | Polymerizable liquid | | | | |
|---|---|---|---|---|---|---|---|
| | liquid crystal | | crystal compound (II) | | Retardation | | |
| | compound (I) | | and the like | | | Reciprocal | |
| | | Blend | | Blend | | wavelength | Surface |
| | Type | amount | Type | amount | Re(450)/Re(550) | dispersibility | condition |
| Example 1 | (I-1) | 12 | (II-1) | 3 | 0.69 | A1 | A |
| Example 2 | (I-2) | 12 | (II-4) | 3 | 0.91 | A3 | A |
| Example 3 | (I-2) | 12 | (II-5) | 3 | 0.89 | A3 | A |
| Example 4 | (I-3) | 12 | (II-4) | 3 | 0.91 | A3 | B |
| Example 5 | (I-4) | 12 | (II-4) | 3 | 0.91 | A3 | B |
| Example 6 | (I-5) | 12 | (II-2) | 3 | 0.67 | A1 | B |
| Example 7 | (I-5) | 12 | (II-3) | 3 | 0.69 | A1 | A |
| Example 8 | (I-7) | 12 | (II-4) | 3 | 0.79 | A2 | A |
| Example 9 | (I-5) | 3 | (II-4) | 3 | 0.75 | A2 | A |
| | (I-6) | 3 | | | | | |
| | (I-7) | 6 | | | | | |
| Example 10 | (I-5) | 6/6 | (II-5) | 3 | 0.73 | A2 | A |
| | (I-7) | | | | | | |
| Example 11 | (I-5) | 6/6 | Mixture | 3 | 0.73 | A2 | A |
| | (I-7) | | (II-6) | | | | |
| Example 12 | (I-5) | 6/6 | Mixture | 3 | 0.73 | A2 | A |
| | (I-7) | | (II-6) | | | | |
| Comparative | (I-1) | 12 | Comparative | 3 | 0.84 | A3 | B |
| Example 1 | | | compound 1 | | | | |
| Comparative | (I-1) | 15 | None | 0 | 0.62 | A1 | C |
| Example 2 | | | | | | | |
| Comparative | (I-3) | 12 | Comparative | 3 | 1.03 | D | C |
| Example 3 | | | compound 1 | | | | |
| Comparative | (I-3) | 15 | None | 0 | 0.81 | A3 | C |
| Example 4 | | | | | | | |

From the results shown in Table 7, it was found that in a case where the polymerizable liquid crystal compound (I) was blended and the compound corresponding to the polymerizable compound (II) was not blended, the surface condition of an optically anisotropic film thus formed may be deteriorated (Comparative Examples 2 and 4).

Furthermore, it was found that in a case where the polymerizable liquid crystal compound (I) was blended and another compound not corresponding to the polymerizable compound (II) was blended, the surface condition of an optically anisotropic film thus formed was improved, but the reciprocal wavelength dispersibility was deteriorated as compared with Comparative Example 2 as a reference (Comparative Example 1).

In addition, it was found that in a case where the polymerizable liquid crystal compound (I) was blended and another compound not corresponding to the polymerizable compound (II) was blended, the surface condition of an optically anisotropic film thus formed was deteriorated and the reciprocal wavelength dispersibility was deteriorated as compared with Comparative Example 4 as a reference (Comparative Example 3).

In contrast, it was found that in a case where both the polymerizable liquid crystal compound (I) and the polymerizable compound (II) were blended, the surface condition of an optically anisotropic film thus formed was improved (Examples 1 to 12).

In addition, from the comparison between Example 1 and Comparative Example 2 or from the comparison between Example 4 and Comparative Example 3, it was found that even if the polymerizable compound (II) is blended, it is possible to retain good reciprocal wavelength dispersibility of an optically anisotropic film thus formed.

### Examples 13 to 21

An optically anisotropic film was formed by the same method as in Examples 1 to 12, except that the polymerizable liquid crystal compound (I) and the polymerizable compound (II) were changed as shown in Table 8 below, and the retardation and the wavelength dispersibility were evaluated. The results are shown in Table 8 below.

TABLE 8

| | Polymerizable | | Polymerizable liquid | | | | |
|---|---|---|---|---|---|---|---|
| | liquid crystal | | crystal compound (II) | | Retardation | | |
| | compound (I) | | and the like | | | Reciprocal | |
| | | Blend | | Blend | | wavelength | Surface |
| | Type | amount | Type | amount | Re(450)/Re(550) | dispersibility | condition |
| Example 13 | (I-5) | 6/6 | (II-7) | 3 | 0.74 | A2 | B |
| | (I-7) | | | | | | |
| Example 14 | (I-5) | 6/3 | (II-7) | 6 | 0.84 | A3 | A |
| | (I-7) | | | | | | |
| Example 15 | (I-5) | 5/5 | (II-8) | 5 | 0.79 | A2 | A |
| | (I-7) | | | | | | |
| Example 16 | (I-5) | 6/3 | (II-9) | 6 | 0.85 | A3 | A |
| | (I-7) | | | | | | |
| Example 17 | (I-5) | 6/3 | (II-10) | 6 | 0.84 | A3 | A |
| | (I-7) | | | | | | |
| Example 18 | (I-5) | 6/3 | (II-11) | 6 | 0.84 | A3 | A |
| | (I-7) | | | | | | |
| Example 19 | (I-5) | 6/3 | (II-12) | 6 | 0.84 | A3 | A |
| | (I-7) | | | | | | |
| Example 20 | (I-5) | 6/3 | (II-13) | 3 | 0.84 | A3 | A |
| | (I-7) | | | | | | |
| Example 21 | (I-2) | 12 | (II-13) | 3 | 0.89 | A3 | A |

From the results shown in Table 8, it was found that in a case where both the polymerizable liquid crystal compound (I) and the polymerizable compound (II) were blended, the surface condition of an optically anisotropic film thus formed was improved (Examples 13 to 21).

### EXPLANATION OF REFERENCES

10: optical film
12: optically anisotropic film
14: alignment film
16: support
18: hard coat layer

What is claimed is:

1. A polymerizable liquid crystal composition comprising:
a polymerizable liquid crystal compound represented by Formula (I); and
a polymerizable compound represented by Formula (II) and not corresponding to Formula (I),
L¹-SP¹-A¹-D³-G¹-D¹-Ar-D²-G²-D⁴-A²-SP²-L² (I)
L⁵-SP⁵-D⁹-C(═O)-Cy¹-Cy²-C(═O)-D⁷-A⁵-D⁸-(A⁶-D¹⁰)ₙ-SP⁶-L⁶ (II)
in Formula (I), D¹, D², D³, and D⁴ each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—,
R¹, R², R³, and R⁴ each independently represent a hydrogen atom, a fluorine atom, or an alkyl group having 1 to 4 carbon atoms,
G¹ and G² each independently represent a divalent alicyclic hydrocarbon group having 5 to 8 carbon atoms, which may have a substituent, and one or more of —CH₂— constituting the alicyclic hydrocarbon group may be substituted with —O—, —S—, or —NH—,
A¹ and A² each independently represent an aromatic ring having 6 or more carbon atoms, which may have a substituent, or a cycloalkane ring having 6 or more carbon atoms, which may have a substituent,
SP¹ and SP² each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent,
L¹ and L² each independently represent a monovalent organic group, and at least one of L¹ or L² represents a polymerizable group, provided that in a case where Ar is an aromatic ring represented by Formula (Ar-3), at least one of L¹ or L², or L³ or L⁴ in Formula (Ar-3) represents a polymerizable group, and
Ar represents any aromatic ring selected from the group consisting of groups represented by Formulae (Ar-1) to (Ar-5), 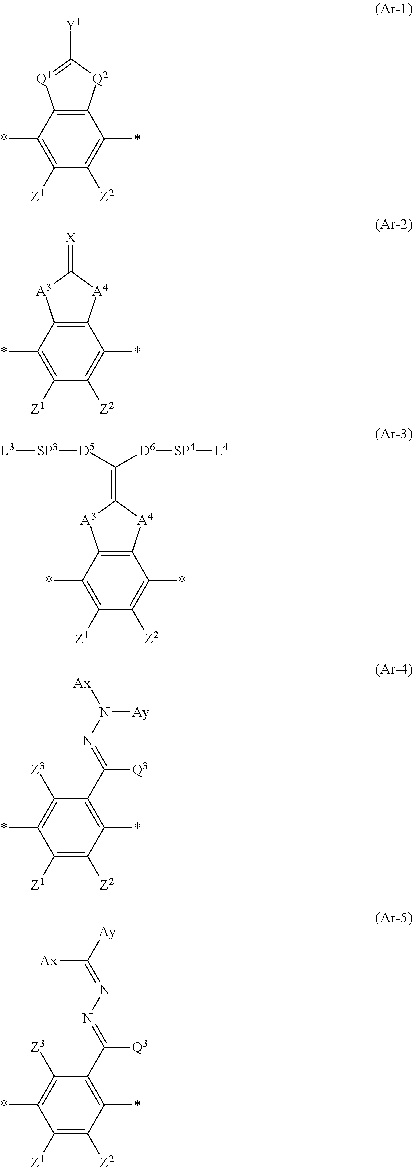
in Formulae (Ar-1) to (Ar-5), * represents a bonding position to D¹ or D²,
Q¹ represents N or CH,
Q² represents —S—, —O—, or —N(R⁵)—, and R⁵ represents a hydrogen atom or an alkyl group having 1 to 6 carbon atoms,
Y¹ represents an aromatic hydrocarbon group having 6 to 12 carbon atoms or an aromatic heterocyclic group having 3 to 12 carbon atoms, each of which may have a substituent,
Z¹, Z², and Z³ each independently represent a hydrogen atom, a monovalent aliphatic hydrocarbon group having 1 to 20 carbon atoms, a monovalent alicyclic hydrocarbon group having 3 to 20 carbon atoms, a monovalent aromatic hydrocarbon group having 6 to 20 carbon atoms, a halogen atom, a cyano group, a nitro group, —OR⁶, —NR⁷R⁸, or —SR⁹, R⁶ to R⁹ each independently represent a hydrogen atom or an alkyl group having 1 to 6 carbon atoms, and Z¹ and Z² may be bonded to each other to form an aromatic ring,
A³ and A⁴ each independently represent a group selected from the group consisting of —O—, —N(R¹⁰)—, —S—, and —CO—, and R¹⁰ represents a hydrogen atom or a substituent,
X represents a hydrogen atom or a non-metal atom of Group XIV to XVI to which a substituent may be bonded,
D⁵ and D⁶ each independently represent a single bond, —CO—O—, —C(═S)O—, —CR¹R²—, —CR¹R²—CR³R⁴—, —O—CR¹R²—, —CR¹R²—O—CR³R⁴—, —CO—O—CR¹R²—, —O—CO—CR¹R²—, —CR¹R²—O—CO—CR³R⁴—, —CR¹R²—CO—O—CR³R⁴—, —NR¹—CR²R³—, or —CO—NR¹—, and R¹, R², R³, and R⁴ each independently represent a hydrogen atom, a fluorine atom, or an alkyl group having 1 to 4 carbon atoms,
SP³ and SP⁴ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent,
L³ and L⁴ each independently represent a monovalent organic group, and at least one of L³ or L⁴, or L¹ or L² in Formula (I) represents a polymerizable group,
Ax represents an organic group having 2 to 30 carbon atoms, which has at least one aromatic ring selected from the group consisting of an aromatic hydrocarbon ring and an aromatic heterocyclic ring,
Ay represents a hydrogen atom, an alkyl group having 1 to 12 carbon atoms, which may have a substituent, or an organic group having 2 to 30 carbon atoms, which has at least one aromatic ring selected from the group consisting of an aromatic hydrocarbon ring and an aromatic heterocyclic ring,
the aromatic rings in each of Ax and Ay may have a substituent, and Ax and Ay may be bonded to each other to form a ring,
Q³ represents a hydrogen atom, or an alkyl group having 1 to 6 carbon atoms, which may have a substituent,
in Formula (II), Cy¹ and Cy² each represent a 1,4-cyclohexylene group,
D⁷ represents a single bond, —O—, —S—, —NR¹¹—, *—O—CR¹¹R¹²—, or *—O—CR¹¹R¹²—CR¹³R¹⁴—, in which * represents a bonding position to C(═O), and R¹¹, R¹², R¹³, and R¹⁴ each independently represent a hydrogen atom, a fluorine atom, or an alkyl group having 1 to 4 carbon atoms,
D⁹ represents a single bond, —O—, —S—, or —NR¹¹—, and R¹¹ represents a hydrogen atom, a fluorine atom, or an alkyl group having 1 to 4 carbon atoms,
D⁸ and D¹⁰ each independently represent a single bond, or a divalent linking group consisting of —CO—, —O—, —S—, —C(═S)—, —CR¹¹R¹²—, —CR¹¹═CR¹²—, —NR¹¹—, or a combination of two or more thereof, and R¹¹ and R¹² each independently represent a hydrogen atom, a fluorine atom, or an alkyl group having 1 to 4 carbon atoms,
SP⁵ and SP⁶ each independently represent a single bond, a linear or branched alkylene group having 1 to 12 carbon atoms, or a divalent linking group in which one or more of —CH₂—'s constituting the linear or branched alkylene group having 1 to 12 carbon atoms are substituted with —O—, —S—, —NH—, —N(Q)-, or —CO—, and Q represents a substituent,
L⁵ and L⁶ each independently represent a monovalent organic group, and at least L⁵ of L⁵ and L⁶ represents a polymerizable group,
A⁵ and A⁶ each independently represent an aromatic ring, a heterocyclic ring, or an alicyclic ring, each of which may have a substituent, and
n represents an integer of 0 to 3, and in a case where n is 2 or 3, a plurality of A⁶'s may be the same as or different from each other and a plurality of D¹⁰'s may be the same as or different from each other.

2. The polymerizable liquid crystal composition according to claim 1,
wherein n in Formula (II) is an integer of 0 to 2.

3. The polymerizable liquid crystal composition according to claim 1,
wherein A⁵ in Formula (II) represents any one ring structure selected from the group consisting of groups represented by Formulae (A5-1) to (A5-5), 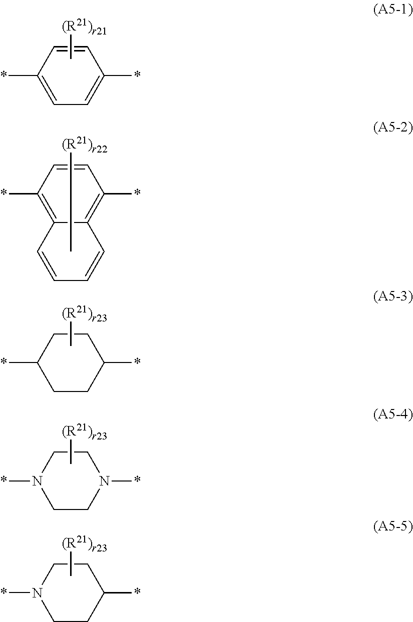
in Formulae (A5-1) to (A5-5), * represents a bonding position to D⁷ or D⁸,
R²¹ represents a substituent, and r21 represents an integer of 0 to 4,
R²² represents a substituent, and r²² represents an integer of 0 to 6, and
R²³ represents an alkyl group having 1 to 5 carbon atoms, and r²³ represents an integer of 0 to 8.

4. The polymerizable liquid crystal composition according to claim 1,
wherein the polymerizable compound represented by Formula (II) is a polymerizable compound represented by Formula (IIa),
L⁵-SP⁵-D⁹-C(═O)-Cy¹-Cy²-C(═O)-D⁷-A⁵-D¹¹-C(═O)-Cy³-Cy⁴-C(═O)-D¹²-SP⁶-L⁶ (IIa)
in Formula (IIa), Cy¹, Cy², D⁷, D⁹, SP⁵, SP⁶, L⁵, L and A⁵ are each the same as those in Formula (II),
Cy³ and Cy⁴ each represent a 1,4-cyclohexylene group,
D¹¹ represents a single bond, —O—, —S—, —NR¹¹—, *—O—CR¹¹R¹²—, or *—O—CR¹¹R¹²—CR¹³R¹⁴—, in which * represents a bonding position to C(═O), and R¹¹, R¹², R¹³, and R¹⁴ each independently represent a hydrogen atom, a fluorine atom, or an alkyl group having 1 to 4 carbon atoms, and
D¹² represents a single bond, —O—, —S—, or —NR¹¹—, and R¹¹ represents a hydrogen atom, a fluorine atom, or an alkyl group having 1 to 4 carbon atoms.

5. The polymerizable liquid crystal composition according to claim 4,
wherein D⁷, D⁹, D¹¹, and D¹² in Formula (IIa) each independently represent —O— or —N(CH₃)—.

6. The polymerizable liquid crystal composition according to claim 1,
wherein A¹ and A² in Formula (I) each independently represent a cycloalkane ring having 6 or more carbon atoms.

7. An optically anisotropic film obtained by polymerizing the polymerizable liquid crystal composition according to claim 1.

8. The optically anisotropic film according to claim 7,
wherein Formula (III) is satisfied,
0.50<Re(450)/Re(550)<1.00 (III)
in Formula (III), Re(450) represents an in-plane retardation of the optically anisotropic film at a wavelength of 450 nm, and Re(550) represents an in-plane retardation of the optically anisotropic film at a wavelength of 550 nm.

9. An optical film comprising the optically anisotropic film according to claim 7.

10. A polarizing plate comprising:
the optical film according to claim 9; and
a polarizer.

11. An image display device comprising the optical film according to claim 9.

12. An image display device comprising the polarizing plate according to claim 10.

13. The polymerizable liquid crystal composition according to claim 2,
wherein A⁵ in Formula (II) represents any one ring structure selected from the group consisting of groups represented by Formulae (A5-1) to (A5-5), 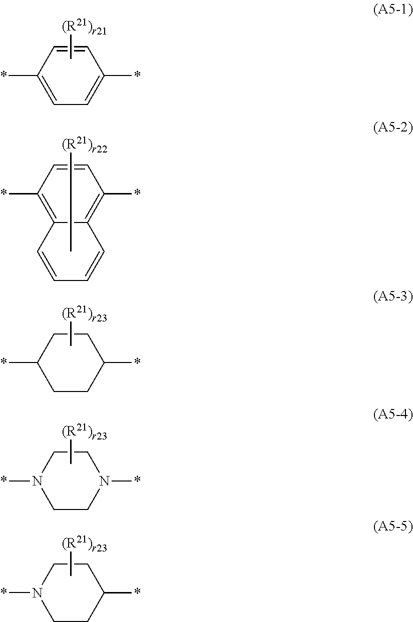
in Formulae (A5-1) to (A5-5), * represents a bonding position to D⁷ or D⁸,
R²¹ represents a substituent, and r21 represents an integer of 0 to 4,
R²² represents a substituent, and r²² represents an integer of 0 to 6, and
R²³ represents an alkyl group having 1 to 5 carbon atoms, and r²³ represents an integer of 0 to 8.

14. The polymerizable liquid crystal composition according to claim 2,
wherein the polymerizable compound represented by Formula (II) is a polymerizable compound represented by Formula (IIa),
L⁵-SP⁵-D⁹-C(═O)-Cy¹-Cy²-C(═O)-D⁷-A⁵-D¹¹-C(═O)-Cy³-Cy⁴-C(═O)-D¹²-SP⁶-L⁶ (IIa)
in Formula (IIa), Cy¹, Cy², D⁷, D⁹, SP⁵, SP⁶, L⁵, L⁶, and A⁵ are each the same as those in Formula (II),
Cy³ and Cy⁴ each represent a 1,4-cyclohexylene group,
D¹¹ represents a single bond, —O—, —S—, —NR¹¹—, *—O—CR¹¹R¹²—, or *—O—CR¹¹R¹²—CR¹³R¹⁴—, in which * represents a bonding position to C(═O), and R¹¹, R¹², R¹³, and R¹⁴ each independently represent a hydrogen atom, a fluorine atom, or an alkyl group having 1 to 4 carbon atoms, and
D¹² represents a single bond, —O—, —S—, or —NR¹¹—, and R¹¹ represents a hydrogen atom, a fluorine atom, or an alkyl group having 1 to 4 carbon atoms.

15. An optically anisotropic film obtained by polymerizing the polymerizable liquid crystal composition according to claim 2.

16. The optically anisotropic film according to claim 15,
wherein Formula (III) is satisfied,
0.50<Re(450)/Re(550)<1.00 (III)
in Formula (III), Re(450) represents an in-plane retardation of the optically anisotropic film at a wavelength of 450 nm, and Re(550) represents an in-plane retardation of the optically anisotropic film at a wavelength of 550 nm.

17. An optical film comprising the optically anisotropic film according to claim 16.

18. A polarizing plate comprising:
the optical film according to claim 17; and
a polarizer.

19. An image display device comprising the optical film according to claim 17.

20. An image display device comprising the polarizing plate according to claim 18.
